(19) United States
(12) Patent Application Publication
(10) Pub. No.: US 2010/0312991 A1
(43) Pub. Date: Dec. 9, 2010

(54) Microprocessor with Compact Instruction Set Architecture

(75) Inventors: Erik K. NORDEN, Munchen (DE); James Hippisley Robinson, New York, NY (US); David Yiu-Man Lau, San Jose, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: MIPS Technologies, Inc., Sunnyvale, CA (US)

(21) Appl. No.: 12/748,102

(22) Filed: Mar. 26, 2010

Related U.S. Application Data
(63) Continuation-in-part of application No. 12/463,330, filed on May 8, 2009.
(60) Provisional application No. 61/051,642, filed on May 8, 2008.

(51) Int. Cl. G06F 9/30; G06F 9/38

(52) U.S. Cl. 712/205; 712/208; 712/234; 712/E09.016; 712/E09.045

(57) ABSTRACT

A re-encoded instruction set architecture (ISA) provides smaller bit-width instructions or a combination of smaller and larger bit-width instructions to improve instruction execution efficiency and reduce code footprint. The ISA can be re-encoded from a legacy ISA having larger bit-width instructions, and the re-encoded ISA can maintain assembly-level compatibility with the ISA from which it is derived. In addition, the re-encoded ISA can have new and different types of additional instructions, including instructions with encoded arguments determined by statistical analysis and instructions that have the effect of combinations of instructions.

### CROSS REFERENCE TO RELATED APPLICATIONS

This application claims benefit under 35 U.S.C. §120 as a continuation-in-part to U.S. patent application Ser. No. 12/463,330, filed May 8, 2009, entitled “Microprocessor with Compact Instruction Set Architecture.” U.S. patent application Ser. No. 12/463,330 claims the benefit of U.S. Provisional Patent Application No. 61/051,642 filed on May 8, 2008, entitled “Compact Instruction Set Architecture.” The subject matter of all of the above-referenced applications are incorporated herein by reference as if fully set forth herein.

### FIELD OF THE INVENTION

Embodiments of the present invention relate generally to microprocessors. More particularly, embodiments of the present invention relate to instruction set architectures for microprocessors.

### BACKGROUND OF THE INVENTION

There is an expanding need for economical, high performance microprocessors, especially for deeply embedded applications such as microcontroller applications. As a result, microprocessor customers require efficient solutions that can be quickly and effectively integrated into products. Moreover, designers and microprocessor customers continue to demand lower power consumption, and have recently focused on environmentally friendly microprocessor-powered devices.

One way to achieve these requirements is to revise an existing instruction set (also known herein as an Instruction Set Architecture (ISA)) into a new instruction set having a smaller code footprint. The smaller code footprint generally translates into lower power consumption per executed task. Smaller instruction sizes, also known as “code compression” may also lead to higher performance. One reason for this improved efficiency is the lower number of memory accesses required to fetch the smaller instruction. Additional benefits may be derived by basing a new ISA on a combination of smaller bit-width and larger bit-width instructions derived from an existing ISA having a larger bit-width.

### SUMMARY OF THE INVENTION

Embodiments of the present invention relate to re-encoding instruction set architectures to be used with a microprocessor, and new instructions resulting therefrom. According to an embodiment, a larger bit-width instruction set is re-encoded to a smaller bit-width instruction set or an instruction set having a combination of smaller bit-width instructions and larger bit-width instructions. In embodiments, the smaller bit-width instruction set retains assembly-level compatibility with the larger bit-width instruction set from which it is derived and has different types of instructions added. Moreover, the new smaller bit-width instruction set or combined smaller and larger bit-width instruction sets may be more efficient and have higher performance than the larger bit-width instruction set from which it was re-encoded.

In an embodiment, several new smaller bit-width instructions are added to the new instruction set, including: Compact Jump Register (JRC), Jump Register, Adjust Stack Pointer (16-Bit) (JRADDIUSP), Add Immediate Unsigned Word 5-Bit Register Select (16-Bit) (ADDIUS5), Move a Pair of Registers (MOVEP), and Jump and Link Register, Short Delay-Slot (16-bit) (JALRS16),

In another embodiment, several new instructions are added to the new instruction set that are of the same size as the original instruction set, including: Compact Branch on Equal to Zero (BEQZC), Compact Branch on not Equal to Zero (BNEZC), Jump and Link Exchange (JALX), Load Word Pair (LWP), Load Word Multiple (LWM), Store Word Pair (SWP) and Store Word Multiple (SWM), Add Immediate Unsigned Word (PC-Relative) (ADDIUPC), Branch on Greater Than or Equal to Zero and Link, Short Delay-Slot (BGEZALS), Branch on Less Than Zero and Link, Short Delay-Slot (BLTZALS), Jump and Link Register, Short Delay Slot (JALRS), Jump and Link Register with Hazard Barrier, Short Delay-Slot (JALRS.HB) and Jump and Link, Short Delay Slot (JALS).

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a schematic diagram of a format of a 32-bit instruction for an ISA according to an embodiment of the present invention.

FIG. 2 is a schematic diagram of a format of a 16-bit instruction for an ISA according to an embodiment of the present invention.

FIG. 3A is a schematic diagram illustrating the format for a Compact Branch on Equal to Zero (BEQZC) instruction according to an embodiment of the present invention.

FIG. 3B is a flowchart illustrating operation of a BEQZC instruction in a microprocessor according to an embodiment of the present invention.

FIG. 3C is a schematic diagram illustrating the format for a Compact Branch on Not Equal to Zero (BNEZC) instruction according to an embodiment of the present invention.

FIG. 3D is a flowchart illustrating operation of a BNEZC instruction in a microprocessor according to an embodiment of the present invention.

FIG. 3E is a schematic diagram showing the format for a Jump and Link Exchange (JALX) instruction according to an embodiment of the present invention.

FIG. 3F is a flowchart illustrating operation of a JALX instruction in a microprocessor according to an embodiment.

FIG. 3G is a schematic diagram showing the format of a second embodiment of the JALX instruction.

FIG. 3H is a flowchart illustrating operation of the second embodiment of the JALX instruction according to a second embodiment.

FIG. 3I is a schematic diagram showing the format for a Compact Jump Register (JRC) instruction according to an embodiment of the present invention.

FIG. 3J is a flowchart illustrating operation of a JRC instruction in a microprocessor according to an embodiment.

FIG. 3K is schematic diagram showing the format for a Load Word Pair (LWP) instruction according to an embodiment of the present invention.

FIG. 3L is a flowchart illustrating operation of an LWP instruction according to an embodiment.

FIG. 3M is a schematic diagram showing the format for a Load Word Multiple (LWM) instruction according to an embodiment of the present invention.

FIG. 3N is a flowchart illustrating operation of the LWM instruction in a microprocessor according to an embodiment.

FIG. 3O is a schematic diagram showing the format for a Store Word Pair (SWP) instruction according to an embodiment of the present invention.

FIG. 3P is a flowchart illustrating operation of an SWP instruction according to an embodiment.

FIG. 3Q is a schematic diagram showing the format for a Store Word Multiple (SWM) instruction according to an embodiment of the present invention.

FIG. 3R is a flowchart illustrating operation of a SWM instruction according to an embodiment.

FIG. 4A is a schematic diagram illustrating the format for a Jump Register, Adjust Stack Pointer (16-Bit) (JRADDIUSP) instruction according to an embodiment of the present invention.

FIG. 4B is a flowchart illustrating operation of a JRADDIUSP instruction in a microprocessor according to an embodiment of the present invention.

FIG. 4C is a schematic diagram illustrating the format for a Add Immediate Unsigned Word 5-Bit Register Select (16-Bit) (ADDIUS5) instruction according to an embodiment of the present invention.

FIG. 4D is a flowchart illustrating operation of an ADDIUS5 instruction in a microprocessor according to an embodiment of the present invention.

FIG. 4E is a schematic diagram showing the format for a Add Immediate Unsigned Word (PC-Relative) (ADDIUPC) instruction according to an embodiment of the present invention.

FIG. 4F is a flowchart illustrating operation of an ADDIUPC instruction in a microprocessor according to an embodiment.

FIG. 4G is a schematic diagram showing the format of a Move a Pair of Registers (MOVED) instruction according to an embodiment of the present invention.

FIG. 4H is a flowchart illustrating operation of the MOVEP instruction according to an embodiment of the present invention.

FIG. 5A is a schematic diagram illustrating the format for a Branch on Greater Than or Equal to Zero and Link, Short Delay-Slot (BGEZALS) instruction according to an embodiment of the present invention.

FIG. 5B is a flowchart illustrating operation of a BGEZALS instruction in a microprocessor according to an embodiment of the present invention.

FIG. 5C is a schematic diagram illustrating the format for a Branch on Less Than Zero and Link, Short Delay-Slot (BLTZALS) instruction according to an embodiment of the present invention.

FIG. 5D is a flowchart illustrating operation of a BLTZALS instruction in a microprocessor according to an embodiment of the present invention.

FIG. 5E is a schematic diagram showing the format for a Jump and Link Register, Short Delay-Slot (16-bit) (JALRS16) instruction according to an embodiment of the present invention.

FIG. 5F is a flowchart illustrating operation of a JALRS16 instruction in a microprocessor according to an embodiment.

FIG. 5G is a schematic diagram illustrating the format for a Jump and Link Register, Short Delay Slot (JALRS) instruction according to an embodiment of the present invention.

FIG. 5H is a flowchart illustrating operation of the JALRS instruction according to a second embodiment.

FIG. 5I is a schematic diagram showing the format for a Jump and Link Register with Hazard Barrier, Short Delay-Slot (JALRS.HB) according to an embodiment of the present invention.

FIG. 5J is a flowchart illustrating operation of a JALRS.HB instruction in a microprocessor according to an embodiment.

FIG. 5K is schematic diagram showing the format for a Jump and Link, Short Delay Slot (JALS) instruction according to an embodiment of the present invention.

FIG. 5L is a flowchart illustrating operation of a JALS instruction according to an embodiment.

FIG. 6 is a schematic diagram of a microprocessor core according to an embodiment of the present invention.

### DETAILED DESCRIPTION OF EMBODIMENTS

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility. The following sections describe an instruction set architecture according to an embodiment of the present invention.
I. Overview
II. Re-encoded Architecture
   a. Assembly Level Compatibility
   b. Special Event ISA Mode Selection
III. New Types of Instructions
   a. Re-encoded Branch and Jump Instructions
   b. Encoded Fields Based on Analysis of ISA Usage
   c. Optimal Encoding of Instruction Arguments
   d. Delay Slots
   e. Instructions with Reduced Target Registers
   f. Combinations of Existing Instruction Effects
IV. Instruction Formats
   a. Principle Opcode Organization
   b. Major Opcodes
V. New ISA Instructions
VI. Example Processor Core
VII. Software Embodiments
VIII. Conclusion

### I. Overview

Embodiments described herein relate to an ISA comprising instructions to be executed, a microprocessor and a microprocessor on which the instruction of the ISA can be executed, and a method of re-encoding an existing ISA. Some embodiments described herein relate to a new ISA that resulted from re-encoding an existing ISA. Some embodiments described herein relate to a new ISA that resulted from re-encoding an existing larger bit-width ISA to a combined smaller and larger bit-width ISA. In one embodiment, the existing, larger bit-width ISA is MIPS32 available from MIPS, INC. of Sunnyvale, Calif., the new, re-encoded smaller bit-width ISA is the MicroMIPS 16-bit instruction set also available from MIPS, INC., and the new re-encoded larger bit-width ISA is the MicroMIPS 32-bit instruction set, also available from MIPS, INC.

In another embodiment, the larger bit-width architecture may be re-encoded into an improved architecture with the same bit-width or a combination of same bit-width instructions and smaller bit-width instructions. In one embodiment, the re-encoded larger-bit width instruction set is encoded to a same size bit-width ISA, in such a fashion as to be compatible with, and complementary to, a re-encoded smaller bit-width instruction set of the type discussed herein. Embodiments of the re-encoded larger bit width instruction set may be termed as “enhanced,” and may contain various features, discussed below, that allow the new instruction set to be implemented in a parallel mode, where both instruction sets may be utilized on a processor. Re-encoded instruction sets described herein also work in a standalone mode, where only one instruction set is active at a time.

### II. Re-Encoded Architecture

a. Assembly Level Compatibility

Some embodiments described herein retain assembly-level compatibility after re-encoding from the larger bit-width to the smaller bit-width or combined bit width ISAs. To accomplish this, in one embodiment, post-re-encoding assembly language instruction set mnemonics are the same as the instructions from which they are derived. Maintaining assembly level compatibility allows instruction set assembly source code, using the larger bit-width ISA, to be compiled with assembly source code using the smaller bit-width ISA. In other words, an assembler targeting the new ISA embodiments of the present invention can also assemble legacy ISAs from which embodiments of the present invention were derived.

In an embodiment, the assembler determines which instruction-size should be used to process a particular instruction. For example, to differentiate between instructions of different bit-width ISAs, in an embodiment, the opcode mnemonic is extended with a suffix corresponding to the different size. For example, in one embodiment, a “16” or “32” suffix is placed at the end of the instruction before the first “.”, if one exists, to distinguish between 16-bit and 32-bit encoded instructions. For example, in one embodiment, “ADD16” refers to a 16-bit version of an ADD instruction, and “ADD32” refers to a 32-bit version of the ADD instruction. As would be known to one skilled in the art, other suffices may be used.

Other embodiments do not use suffix designations of instruction size. In such embodiments, the bit-width suffices may be omitted. In an embodiment, the assembler will look at the values in a command's register and immediate fields and decide whether a larger or smaller bit-width command is appropriate. Depending upon assembler settings, the assembler may automatically choose the smallest available instruction size when processing a particular instruction.

b. Special Event ISA Mode Selection

In another embodiment, ISA selection occurs in one of the following events: exceptions, interrupts and power-on events. In such an embodiment, a handler that is handling the special event specifies the ISA. For example, on power-on a power-on handler can specify the ISA. Likewise, in an embodiment, an interrupt or exception handler can specify the ISA. In another embodiment, for each event type a user can choose which ISA to use through control bits.

### III. New Types of Instructions

Embodiments having new ISA instructions are be described below, as well as embodiments with re-encoded instructions. Several general principles have been used to develop these instructions, and these are explained below.

a. Re-Encoded Branch and Jump Instructions

In one embodiment, the re-encoded smaller bit-width ISA supports smaller branch target addresses, providing enhanced flexibility. For example, in one embodiment, a 32-bit branch instruction re-encoded as a 16-bit branch instruction supports 16-bit-aligned branch target addresses.

In another example, because the offset field size of the 32-bit re-encoded branch instruction remains identical to the legacy 32-bit re-encoded instructions, the branch range may be smaller. In further embodiments, the jump instructions J, JAL and JALX support the entire jump range by supporting 32-bit aligned target addresses.

b. Encoded Fields Based on Analysis of ISA Usage

The term ‘immediate field’ as used herein and is well known in the art. In embodiments, the immediate field can include the address offset field for branches, load/store instructions, and target fields. In embodiments, the immediate field width and position within the instruction encoding is instruction dependent. In an embodiment, the immediate field of an instruction is split into several fields that need not be adjacent. In another embodiment, an instruction format can have a single, contiguous immediate field.

In an embodiment, use of certain register and immediate values for ISA instructions and macros, may convey a higher level of usefulness than other values. Embodiments described herein use this principle to enhance the usefulness of instructions. For example, to achieve such usefulness, in one embodiment, analysis of the statistical frequency of values used in register and immediate fields over a period of usage of an ISA is performed.

In another embodiment, the statistical analysis may analyze arguments used by instructions, e.g., target registers and immediate values. The usage of arguments can be analyzed for instructions while operating in an ISA to determine a variety of different useful statistics, e.g., the frequency of usage of an argument value generally, the frequency of usage of an argument value for a particular instruction or class of instructions, the frequency of usage of an argument value for a particular type of computer program or user application,

In an example of this statistical analysis and its application, a first ISA has a particular instruction that accepts a 5-bit target register and a 5-bit immediate value. Embodiments described herein, in preparation for the re-encoding of this instruction, collect data about the usage of the particular instruction, specifically, which values are used over time for the target register and the immediate value. In another example, this usage data could be collected for all instructions in the first ISA generally. The example time of collection could be changed depending upon sample requirements.

Continuing with the above example of an embodiment, the collected data about the first ISA generally, and the particular instruction specifically can be used to re-encode the particular instruction, either to be used in the same ISA or a new second ISA. As described herein, one reason to re-encode the instruction is to increase code compression. Based on the collected data described above, the re-encoded version of the particular instruction can have arguments that require less bit-length. In an embodiment, this reduction in size can be accomplished by selecting a subset of the total possible values for an argument, e.g., the target registers and immediate values noted above. For example, out of the 32 possible values that can be referenced by a 5-bit argument, based on the statistical analysis of the type described above, the top 8 most frequently used argument values can be selected. These top-values could, in embodiments be termed the most “useful” values for a particular instruction, ISA, computer program, type of computer program, application, type of application, or other like grouping.

The top 8 example values noted above can be “encoded” into a table structure of the type shown below, e.g., in Table 9. In this way, the re-encoded version of the example instruction cannot operate on the full set of 32 possible values with 5-bit encoding, but does have a smaller amount of bits dedicated in its format to this particular argument. To assist in the re-encoding of an ISA as described herein, the above encoding approach also may allow a reduction in the required size of register and immediate fields, because certain less common values may be omitted from encoding. For example, encoded register and immediate values may be encoded into a shorter bit-width than the original value, e.g., “1001” may encode to “10.” When re-encoding larger bit-width instruction sets to smaller bit-width ISAs, less frequently used values may be omitted from the new list. In embodiments, instructions described herein can be newly created, or re-encoded from existing instructions, to have increased usefulness for these groups.

Further with respect to this example, the smaller space required by arguments in a re-encoded instruction, could enable an instruction having a longer length, e.g., 32-bits, to be re-encoded to a smaller version of the instruction, e.g., 16-bits. In embodiments described herein, both this older, larger instruction and smaller re-encoded instruction could be in an embodiment of a new ISA.

As would be known by one having skill in the art given the descriptions described herein, different statistics could be collected about different components of an instruction to enable a different re-encodings of instructions. Also based on this analysis, other embodiments described herein, instead of using unmodified register or immediate values, encode the values to link the highest usefulness register and immediate values to the most commonly used values, as determined by the statistical analysis above.

c. Optimal Encoding of Instruction Arguments

In an embodiment, with respect to the mappings that link the registers with the highest usefulness and immediate values to the most commonly used values, certain linkings may convey a higher level of usefulness than other linkings. Embodiments described herein use this principle to enhance the usefulness of instructions using encodings.

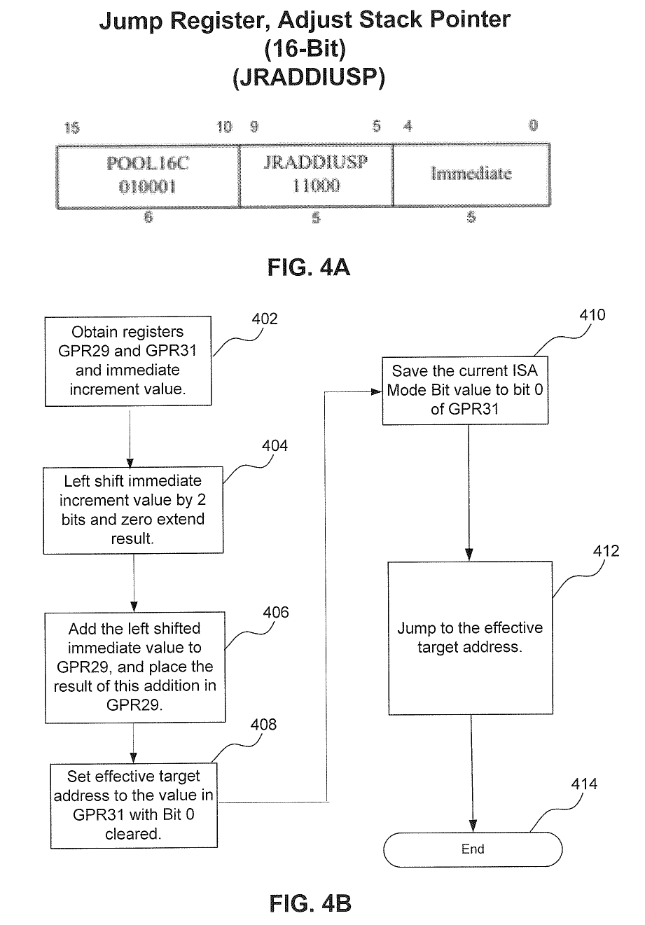

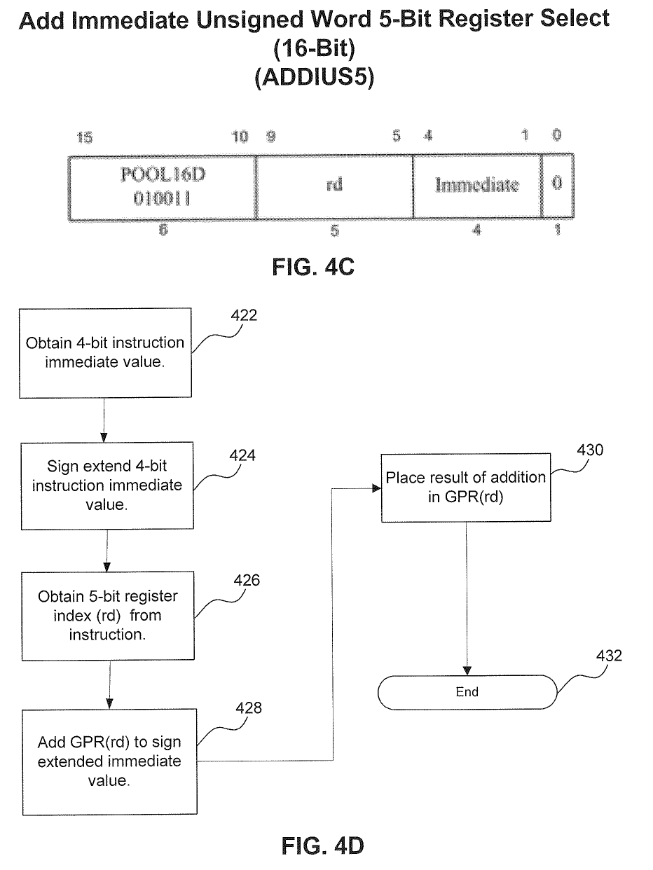

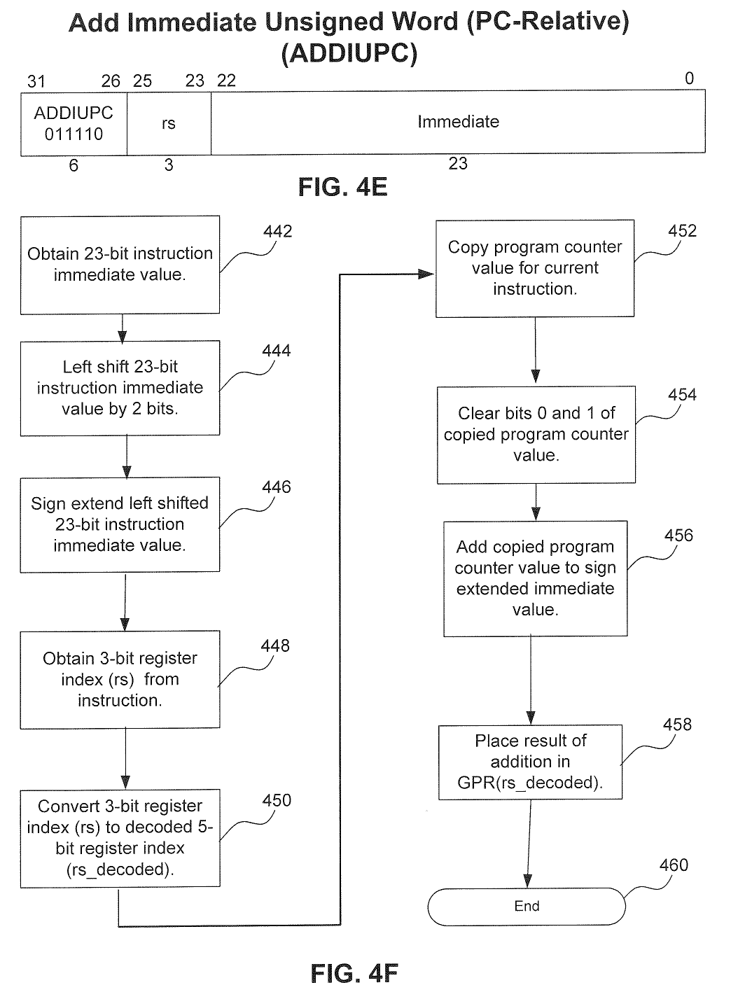

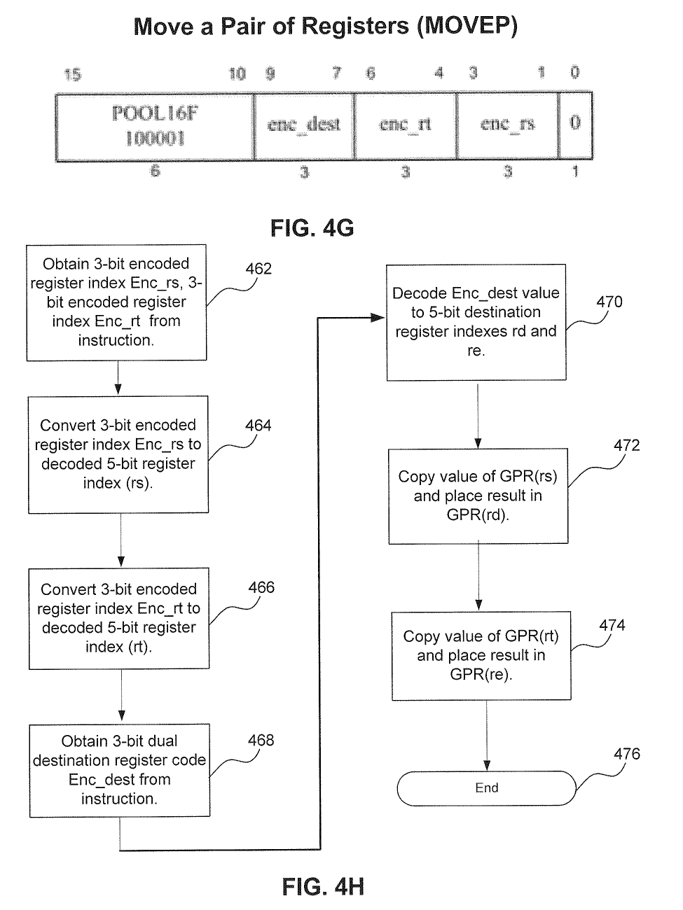

For example, Table 1A depicts the encoded and decoded value of the immediate field of the Move a Pair of Registers (MOVEP) instruction and described below and depicted on FIGS. 4G and 4H. It is to be noted that, in Table 1A, there is not a 1-to-1 value between the Encoded Values (Decimal) and the Decoded Values of rt (or rs) (Decimal). In an embodiment, the mapping value described below that maps the encoded value of 1 to the decoded value of 17 was selected based upon a characteristic of the processor upon which the instruction will be executed. One having skill in the art will appreciate that certain hardware may be able to link one value to another using less computing power.

TABLE 1A
Example Encoded and Decoded Values for MOVEP

| Encoded | Encoded | | |
|---|---|---|---|
| Value of | Value of | Decoded | |
| Instr_{6..4} (or | Instr_{6..4} (or | Value of rt | Symbolic |
| Instr_{3..1}) | Instr_{3..1}) | (or rs) | Name (From |
| (Decimal) | (Hex) | (Decimal) | ArchDefs.h) |
| 0 | 0x0 | 0 | zero |
| 1 | 0x1 | 17 | s1 |
| 2 | 0x2 | 2 | v0 |
| 3 | 0x3 | 3 | v1 |
| 4 | 0x4 | 16 | s0 |
| 5 | 0x5 | 18 | s2 |
| 6 | 0x6 | 19 | s3 |
| 7 | 0x7 | 20 | s4 |

d. Delay Slots

In embodiments of a pipelined architecture, the instruction immediately following a branch is said to be in a branch delay slot. For delayed-branches, the branch delay slot instruction is always executed when the branch is executed. In an embodiment, a delay slot instruction will execute even if the preceding branch is taken. Delay slots may increase efficiency, but are not efficient for all applications. For example, for certain applications (e.g., high performance applications), not using delay slots does not affect code compression, e.g., has little, if any impact on making the resulting code smaller. At times in embodiments, a compiler attempting to fill a delay slot cannot find a useful instruction. In such cases, a no operation (NOP) instruction is placed in the delay slot, which may add to a program's footprint and decrease performance efficiency.

Embodiments described herein offer a developer a choice when using of delay slots. Given this choice, a developer may choose how best to use delay slots so as to maximize desired results, e.g., code size, performance efficiency, instruction usefulness, and ease of development. In an embodiment, certain instructions described herein have two versions—exemplary instructions are the jump and branch instructions. Such instructions have one version with a delay slot and one version without a delay slot. In an embodiment, which version to use is software selected when the instruction is coded. In another embodiment, which version to use is selected by the developer (as with the selection of ADD16 or ADD32 described above). In yet another embodiment, which version to use is selected automatically by the assembler (as described above). This feature in such embodiments may also help maintain compatibility with legacy hardware processors.

In another embodiment, the size of a delay slot is fixed. Embodiments herein involve an instruction set with two sizes of instructions (e.g., 16 bit and 32 bit). A fixed-width delay slot allows a designer to define a delay slot instruction so that the size will always be a certain size, e.g., a larger bit-width slot or shorter bit-width slot. This delay slot selection allows a designer to broadly pursue different development goals. To minimize code footprint, a uniformly smaller bit-width delay slot might be selected. However, this may result in a higher likelihood that the smaller slots might not be filled. In contrast, to maximize the potential performance benefit of the delay slot, a larger bit-width slot may be selected. In embodiments, this choice, however, may increase code footprint.

In an embodiment, delay slot width may be selected by the designer as either a larger bit-width or smaller bit-width at the time the instruction is coded. This is similar to the embodiments described herein that allow for manual selection of instruction bit-width (ADD16 or ADD32). As with the fixed bit-width selection described above, this delay slot selection in embodiments allows a designer to pursue different development goals. With this approach however, the bit-width choice may be made for each command, as opposed to the system overall. In an embodiment, the ability to select delay slot size allows a developer to avoid wasting delay slot space in an ISA with variable length instructions. For example, if a larger delay slot is filled with a smaller length instruction, this may lead to a larger than required code footprint and decrease performance efficiency. In embodiments, a developer may select a smaller delay slot to handle smaller instructions and thus avoid this code inefficiency.

As would be appreciated by one skilled in the art, approaches to delay slots described above may be applied to any instruction that is capable of using delay slots, and other ISA bit-widths.

e. Instructions with Reduced Target Registers

An embodiment of a re-encoded ISA can improve code compression by the addition of new instructions which have the same instruction size or a larger than an original ISA instruction size. In one embodiment, a recoded ISA uses instructions of the same size as instructions in an original ISA, but targets a reduced number of registers in order to increase the number of encoding bits available for other instruction arguments, e.g., instruction immediate fields. In an example, a 32-bit instruction has bits dedicated both to the targeting of a number of registers and to one or more immediate fields. In a re-encoded version of the 32-bit example instruction, only a reduced set of target registers is made available to the re-encoded instruction, thus reducing the number of bits that need to be dedicated to target registers and allowing more bits for the encoding of immediate fields.

In an embodiment, the reduced set of target registers made available under this approach are the most frequently used registers for a particular instruction. As described above, in an embodiment, the reduced set of target registers can be determined by a statistical analysis over a period of usage, of instruction register requirements.

As would be known to one having skill in the art, the above approach could apply to instructions of larger or smaller bit-widths than the example, and other approaches to selecting instruction bit allocations could be used. An example embodiment of this reduced set of target registers is an ADDIUPC instruction as described and depicted on FIGS. 4E and 4F.

f. Combinations of Existing Instruction Effects

In an embodiment, new instructions in a recoded ISA can combine the effect of two or more of the instructions in the original ISA. In an embodiment, combinations of instructions can be identified that are frequently executed in combination, and new instructions can be included in a re-encoded ISA based on this identification. Embodiments can identify combinations of instructions, along with specific subsets of register targets and immediate value choices which can be combined into a single re-encoded instruction in the recoded ISA. In an embodiment, the re-encoded combination instructions use less total encoding bits than the original instructions combined. In an embodiment, in a process similar to the analysis described above, statistical analysis can be used to identify combinations of instructions which are frequently executed in combination.

An embodiment of a re-encoded instruction that, as described above, carries out the same operation as multiple instructions in an existing ISA, can combine the operations of jumping to an address in a register and modifying the value of another register by an amount encoded in an instruction immediate value. An example of this embodiment is the JRADDIUSP instruction as described and depicted on FIGS. 4A and 4B. The JRADDIUSP instruction, in an embodiment, performs the same operations as a MIPS32 “JR” instruction and a MIPS32 “ADDIU” instruction. In an embodiment, to achieve the combination, the “ADDIU” portion of the combination in the JRADDIUSP instruction can only target a subset of the register and immediate fields available to the original “ADDIU” instruction version in MIPS32.

Another embodiment of a re-encoded instruction that, as described above, carries out the same operation as multiple instructions in an original ISA, can copy the values from a pair of source registers into a pair of destination registers. An example of this embodiment is the MOVEP instruction as described and depicted on FIGS. 4G and 4H, such instruction being a MicroMIPS instruction that performs the same operations as a pair of mips32 MOVE instructions, for a statistically chosen subset of target and destination registers.

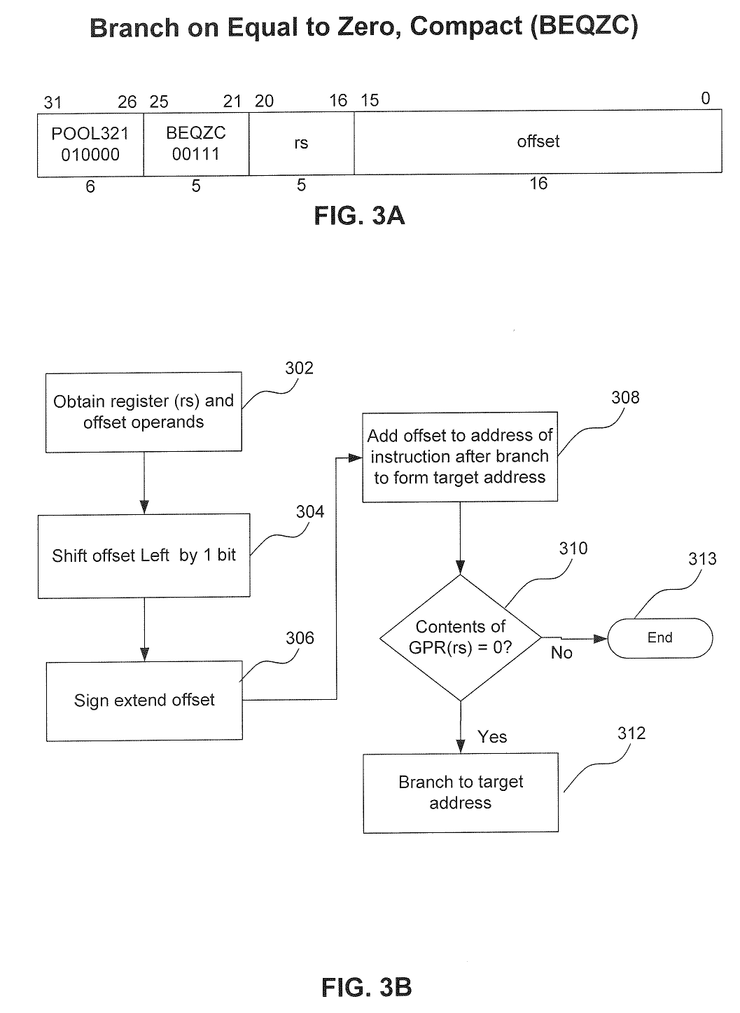

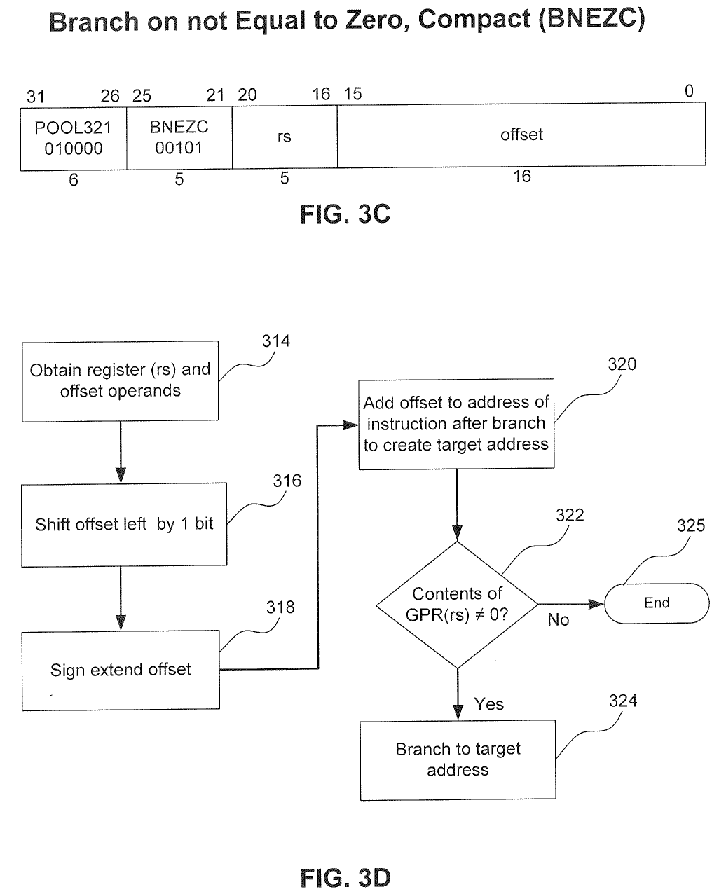

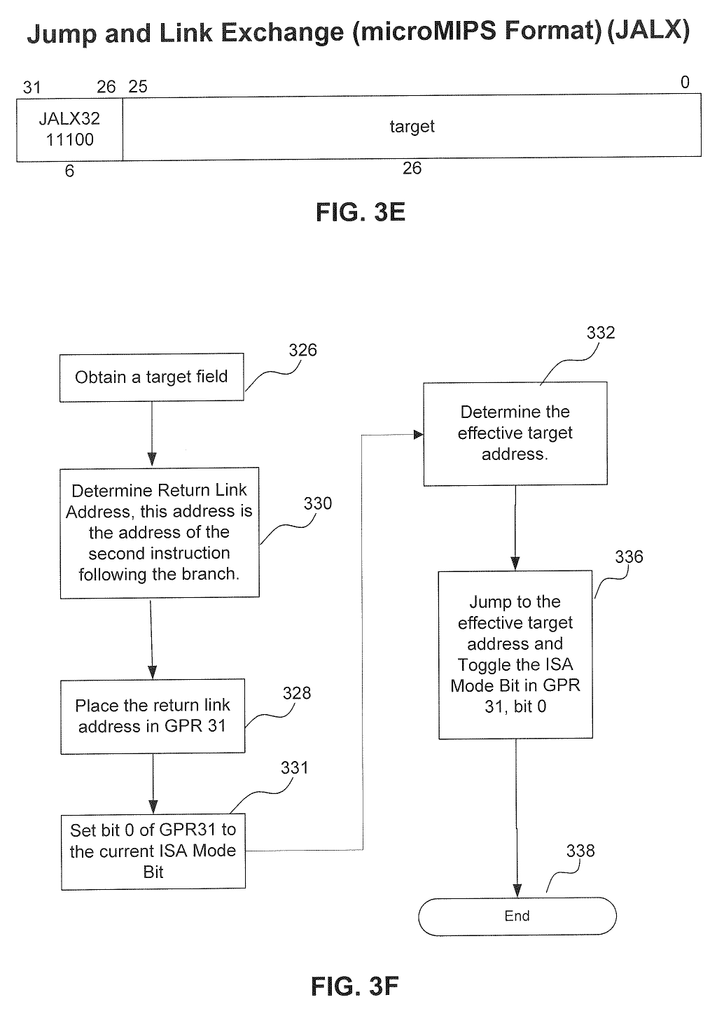

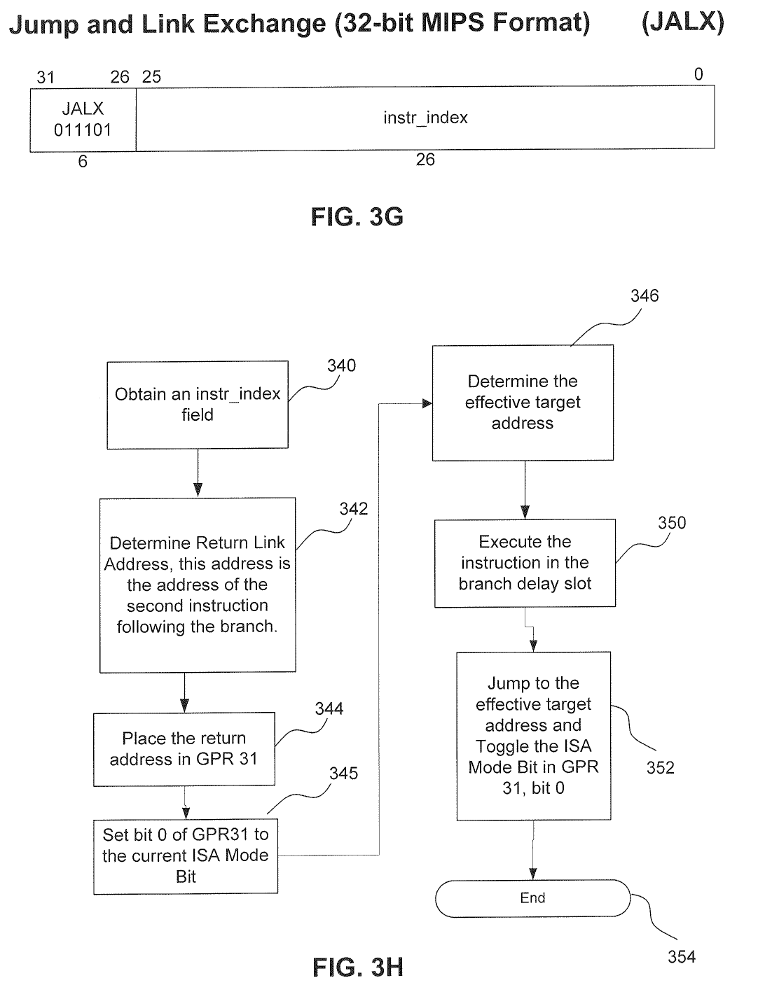

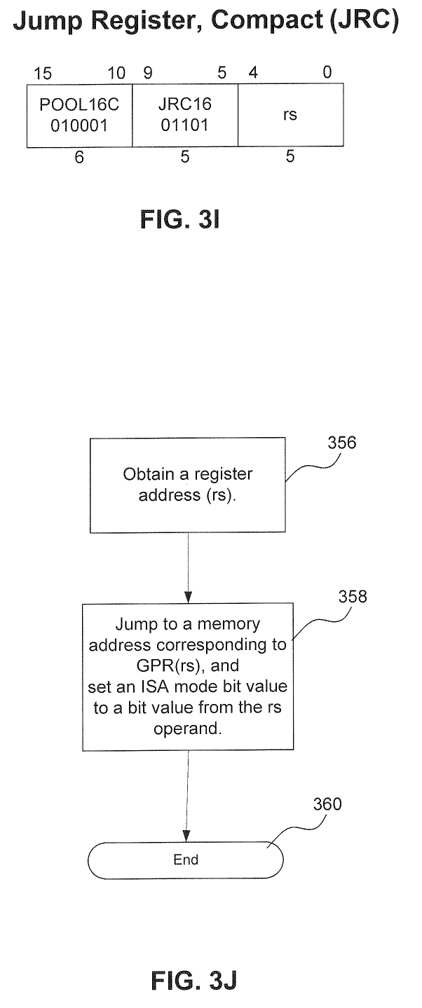

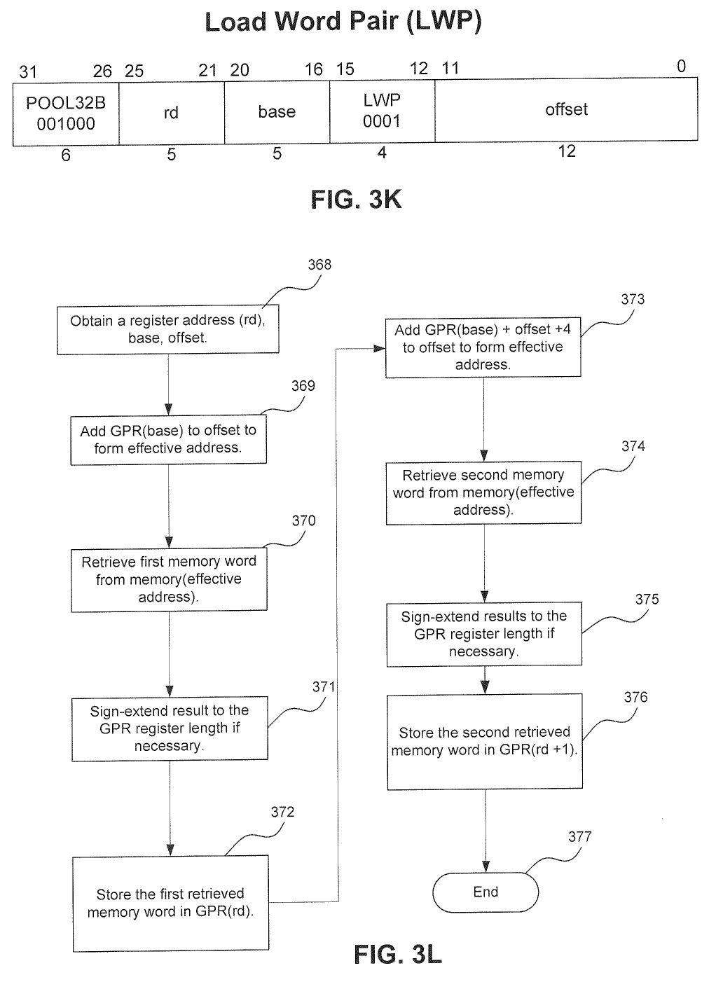

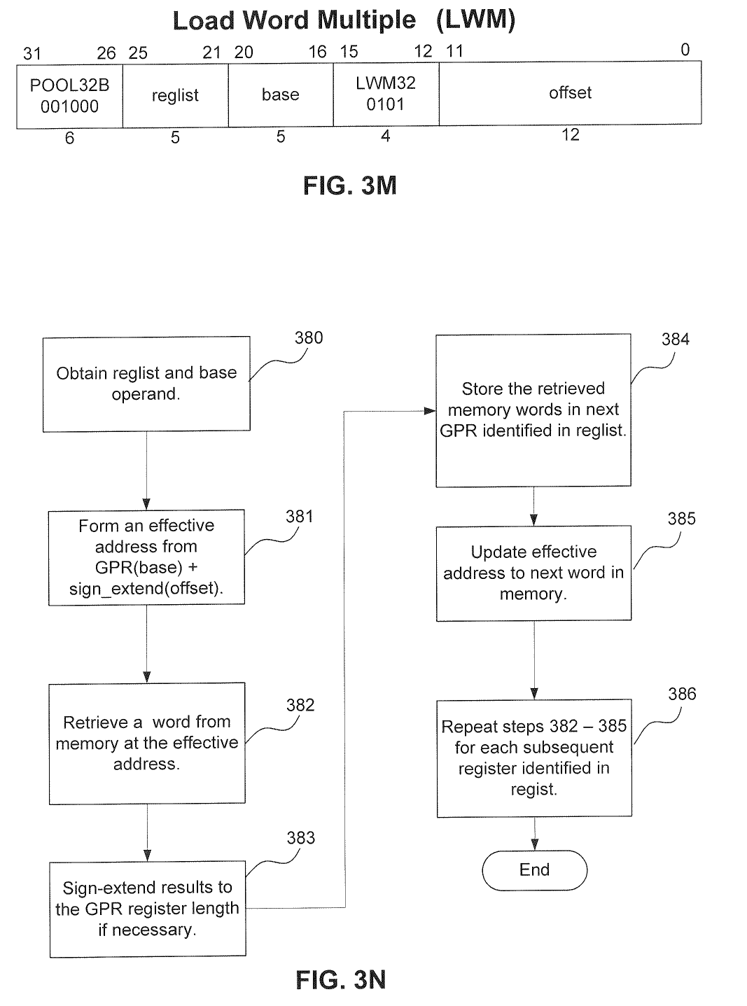

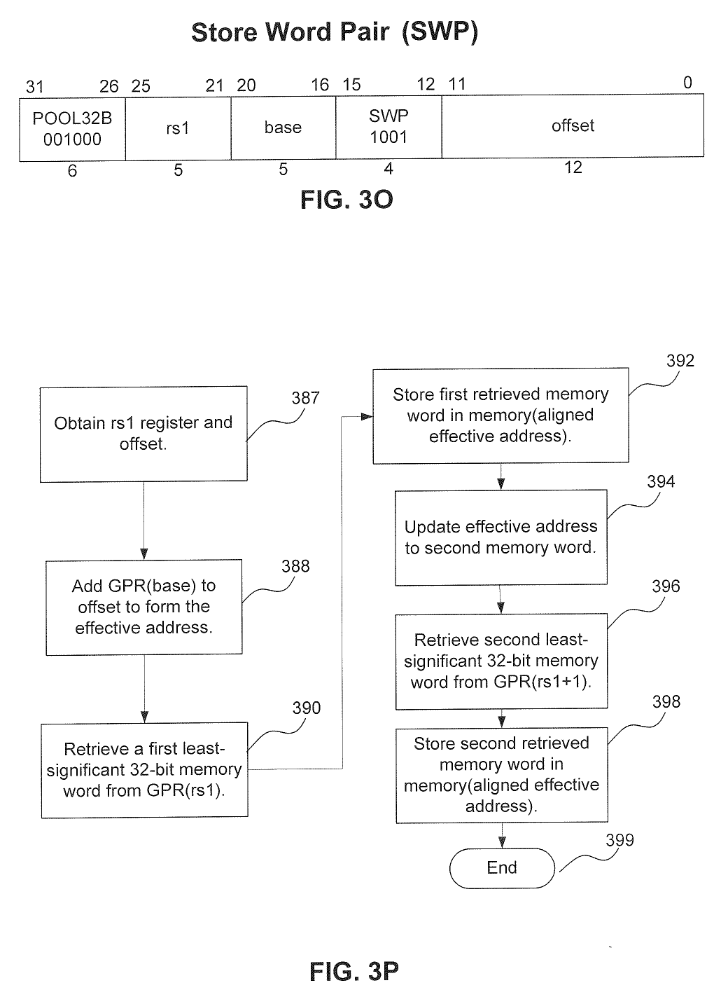

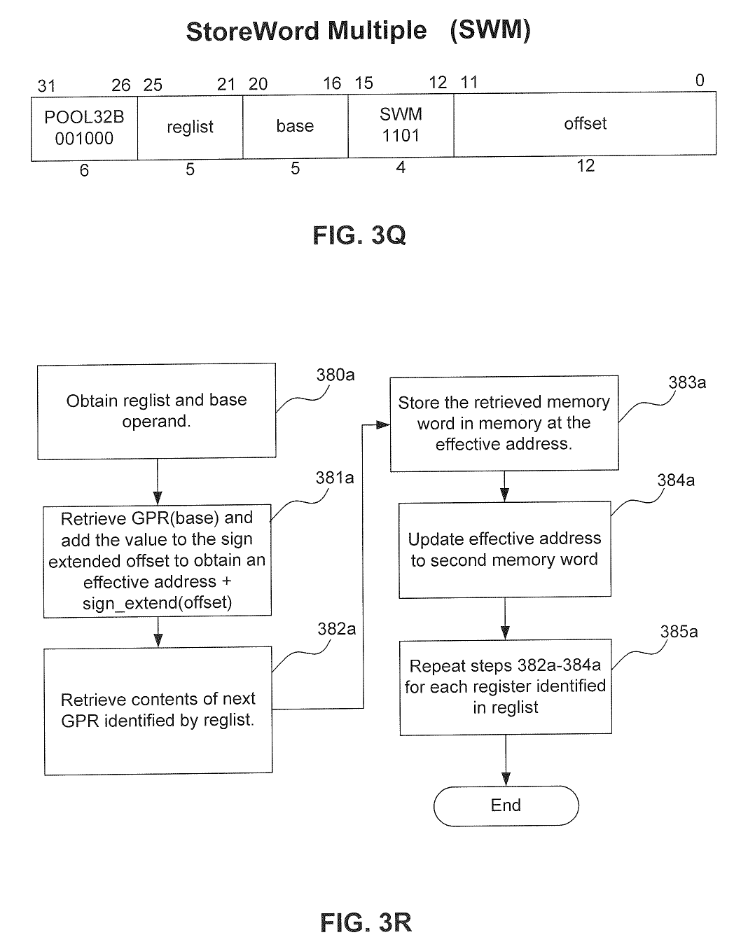

Other embodiments that use this combination technique include: LWP instruction as described and depicted on FIGS. 3K and 3L, the LWM32 instruction as described and depicted on FIGS. 3M and 3N, the SWP instruction as described and depicted on FIGS. 3O and 3P, and the SWM instruction as described and depicted on FIGS. 3Q and 3R.

### IV. Instruction Formats

In an embodiment the new ISA comprises instructions having at least two different bit widths. For example, an ISA according to an embodiment includes instructions that have 16-bit and 32-bit widths. Although embodiments of the new ISA described herein describe two instruction sets that operate in a complementary fashion, the teachings herein would apply to any number of ISA instruction sets.

In an embodiment, instructions have opcodes comprising a major opcode, and in some cases a minor opcode. The major opcode has a fixed width, while the minor opcode has a width that depends on the instruction, including widths large enough to access an entire register set. For example, in one embodiment, the MOVE instruction has a 5-bit minor opcode, and may reach the entire register set. For example, in one embodiment, encoding comprises 16-bit and 32-bit wide instructions, both having a 6-bit major opcode left aligned within the instruction encoding, followed by a variable width minor opcode.

In an embodiment, the major opcode is the same for both the larger bit-width and smaller bit-width instruction sets. For example, in one embodiment, encoding comprises 16-bit and 32-bit wide instructions, both having a 6-bit major opcode left aligned within the instruction encoding, followed by a variable width minor opcode.

a. Principle Opcode Organization

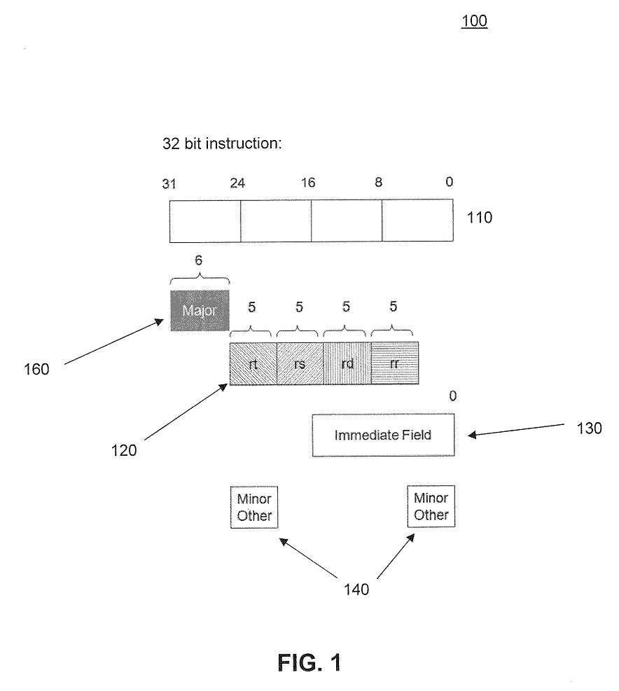

FIG. 1 is a schematic diagram of a format 110 for a 32-bit re-encoded instruction, according to an embodiment. Embodiments of instruction format 110 may have zero, one, or more register fields 120, followed by optional immediate fields 130. In one embodiment, 32-bit re-encoded instructions have 5-bit wide register fields 120. Other optional instruction specific fields 140 may be located between the immediate fields 130 and opcode field 160.

As depicted on FIG. 1, in an exemplary embodiment, instructions can have 0 to 4 target register fields 120, followed by the optional immediate field 130. Other optional instruction specific fields 140 are located between immediate field 130 and opcode fields 150 or 160. In an embodiment, the target register fields 120 may have a fixed placement, e.g., in included, they always appear at the same bit ranges. As described above, the opcode field comprises a major opcode 160 and, in some cases, a minor opcode (not shown). Some embodiments have the following format characteristics:

C1. 6-bit major opcode always at the left-most at bits 31:26.

C2. 5-bit target register fields 120 that are always at fixed locations: If instruction has rt field, it is always located at bits 25:21, just right of major opcode; If instruction has rs field, it is always located at bits 20:16, just right of rt field; If instruction has rd field, it is always located at bits 15:11, just right of rs field; If instruction has rr field, it is always located at bits 10:6, just right of rd field. In an embodiment, because of these fixed locations, the register fields can be used directly to access the register file.

C3. One or more immediate fields 130 that are always right-aligned and always start at bit 0.

C4. Minor 140 & Other fields (not shown): configured to be bit locations not occupied by the register/immediate fields described above.

The above list of characteristics C1-C4 is intended to be non-limiting, and meant to describe different characteristics that can be associated with embodiments described herein. In an embodiment, the left-most bits described in characteristics C1-C4 are the least significant bits in the instruction format, while in another embodiment, the left-most bits described in characteristics C1-C4 are the most significant bits in the instruction format. Characteristics C1-C4 list example values and features that are meant to illustrate embodiments, and one or more may be combined in embodiments. Other values, labels, and structures could be used without departing from the spirit of embodiments described herein.

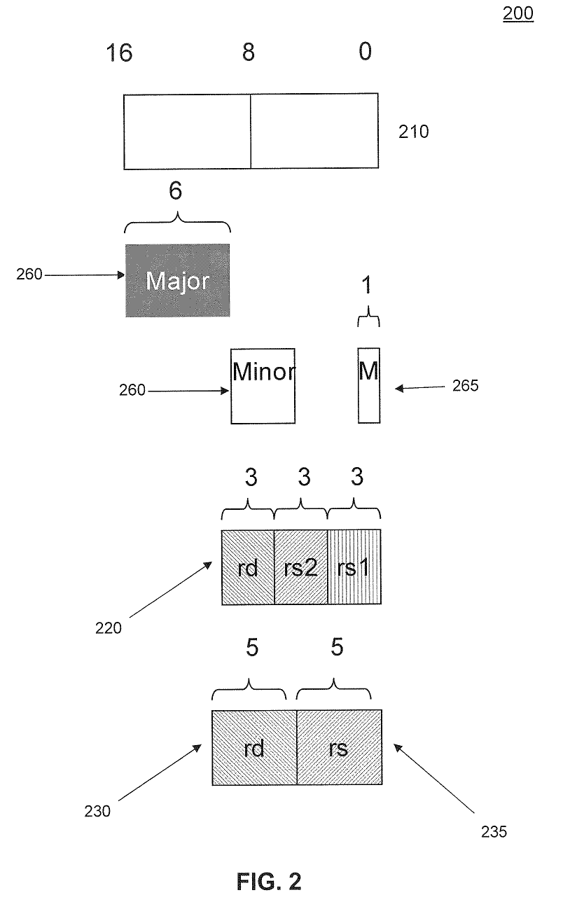

FIG. 2 is a schematic diagram of a format 210 for a 16-bit instruction 200, according to an embodiment. Embodiments of instruction format 210 may have zero, one, or more target register fields 220. In one embodiment, 16-bit instructions use 3-bit registers 220, and use instruction-specific register encoding. In another embodiment, 16-bit instructions use 5-bit registers (rd 230,rs 235). Instruction-specific register encoding relates to the mapping, for a particular instruction, of a particular portion of the register space to 3-bit registers in a 16-bit instruction.

Some embodiments have the following format characteristics:

D1. 6-bit major opcode always left-most at bits 15:10.

D2. If one or more minor opcode fields exist (260, 265), they can be located just right of major opcode field 260 and also in embodiments can be a single bit 265 located at bit 0 (the right-most bit).

D3. For 3-bit target register fields 220, in an embodiment, if the instruction has a 3-bit rd register field, it is the left-most 3-bit register field and if and instruction has other 3-bit register fields, these fields don't have fixed locations. In an embodiment, these register fields don't have fixed location because they are encoded and thus can't be used directly to access register file, as described in characteristic C2 above.

D4. For 5-bit target register fields (230, 235), in an embodiment, if the instruction has a 5-bit rd register field 230 then it's always located at bits 9:5, just to the right of major opcode 260 and if instruction has 5-bit rs register field 235, it's always located at bits 4:0, the right-most 5 bits of the instruction. In an embodiment, these fixed placement 5-bit target registers (230, 235) can be used to directly access the register file as with characteristic C2 above. For example, in one embodiment, a 16-bit MOVE instruction has 5-bit register fields. Use of 5-bit register fields allows the 16-bit MOVE instructions to access any register in a register set having 32 registers.

D5. For immediate/other fields (not shown): These use bit locations not occupied by previously mentioned fields.

The above list of characteristics D1-D5 is intended to be non-limiting, and meant to describe different characteristics that can be associated with embodiments described herein. In an embodiment, the left-most bits described in characteristics D1-D5 are the least significant bits in the instruction format, while in another embodiment, the left-most bits described in characteristics D1-D5 are the most significant bits in the instruction format. Characteristics D1-D5 list example values and features that are meant to illustrate embodiments, and one or more may be combined in embodiments. Other values, labels, and structures could be used without departing from the spirit of embodiments described herein.

b. Major Opcodes

Table 1B provides an example listing of instruction formats for 16-bit instructions in an ISA according to an embodiment, and table 2 provides a listing of instruction formats for 32-bit instructions in an ISA according to another embodiment. As can be seen from Table 1, instructions in the exemplary ISA have 16 or 32 bits. As would be known by one having skill in the relevant arts, nomenclature for the instruction formats appearing in Table 1 are based on the number of register fields and immediate field size for the instruction format. That is, the instruction names have the format R<x>I<y>. Where <x> is the number of register in the instruction format and <y> is the immediate field size. For example, an instruction based on the format R2I16 has two register fields and a 16-bit immediate field.

Table 3 provides an example listing of immediate field formats for 32-bit instructions in an ISA. Table 3 is separated into three sections: 32-bit instruction formats with 26-bit immediate fields, 32-bit instruction formats with 16-bit immediate fields, 32-bit instruction formats with 12-bit immediate fields.

As would be appreciated by one having skill in the relevant arts, different formats could be used to implement embodiments described herein without departing from the spirit of the concepts disclosed.

TABLE 1B
16-Bit Instruction Set Formats

| | |
|---|---|
| S3R0 | 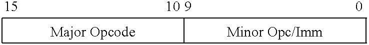 |
| S3R117 | 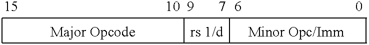 |
| S3R210 | 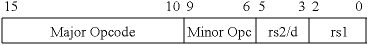 |
| S3R213 | 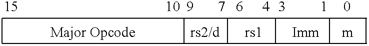 |
| S3R214 | 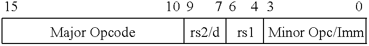 |
| S3R310 | 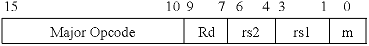 |
| S5R110 | 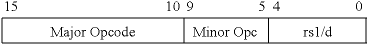 |
| S5R115 | 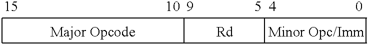 |
| S5R115 | 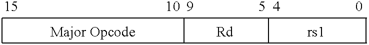 |

TABLE 2
32-Bit Instruction Set Formats

| | |
|---|---|
| R0 | 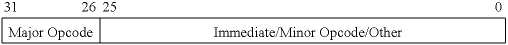 |
| R1 | 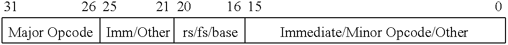 |
| R2 | 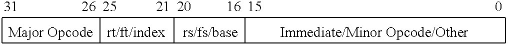 |
| R3 | 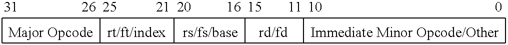 |
| R4 | 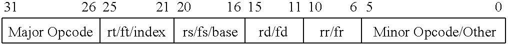 |

TABLE 3
Immediate Fields within 32-Bit Instructions
32-bit instruction formats with 26-bit immediate fields:

| | |
|---|---|
| R0126 | 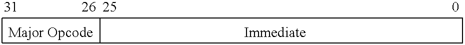 |
| R0116 | 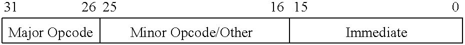 |

32-bit instruction formats with 16-bit immediate fields:

| | |
|---|---|
| R1116 | 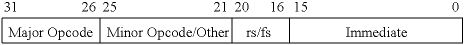 |
| R2116 | 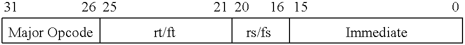 |

32-bit instruction formats with 12-bit immediate fields:

| | |
|---|---|
| R1112 | 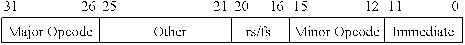 |
| R1112 | 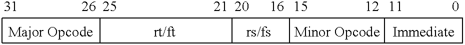 |

### V. Re-Encoded Instructions

In embodiments of a new ISA re-encoded from an existing ISA, new instructions and re-encoded legacy instructions are added. In embodiments, these new and re-encoded instructions are designed to reduce code size. Tables 1B-3 illustrate formats for the re-encoded instructions for an ISA according to an embodiment. Table 4 provides instruction formats for 32-bit instructions of a legacy ISA re-encoded as 16-bit instructions in a new ISA according to an embodiment. In another embodiment, selection of which legacy 32-bit ISA instructions to re-encode as 16-bit new ISA instructions is based on a statistical analysis of legacy code used over a period of time, to determine more frequently used instructions. An exemplary set of such instructions is provided in Tables 2 and 3. Table 3 provides examples of instruction specific register encoding or immediate field size encoding described above. Table 4 provides instruction formats for 32-bit instructions in the new ISA re-encoded from 32-bit instructions in a legacy ISA according to an embodiment. Table 5 provides instruction-specific register specifiers and immediate field values for embodiments of re-encoded instructions according to an embodiment.

Table 6 provides an example listing of the most significant bit formats for an exemplary ISA re-encoding according to an embodiment, such listing showing the register fields, immediate fields, other fields, empty fields, minor opcode field to the major opcode field. As described above, embodiments of 32-bit re-encoded instructions can have 5-bit wide register fields. In an embodiment, 5-bit wide register fields use linear encoding (r0=‘00000’, r1=‘00001’, etc.).

Instructions of 16-bit width can have different size register fields, for example, 3- and 5-bit wide register fields. Register field widths for 16-bit instructions according to an embodiment, are provided in table 1B. The ‘other fields’ are defined by the respective column and the order of these fields in the instruction encoding is defined by the order in the tables.

a. New 16-Bit Instructions Re-Encoded from 32-Bit Instructions

As discussed above, in embodiments described herein, a larger bit-width ISA may be re-encoded to a smaller bit-width ISA or a combined smaller and larger bit-width ISA. In one embodiment, to enable the larger ISA to be re-encoded into a smaller ISA, the smaller bit-width ISA instructions have smaller register and immediate fields. In one embodiment, as described above, this reduction may be accomplished by encoding frequently used registers and immediate values.

In one embodiment, an ISA uses both an enhanced 32-bit instruction set and a narrower re-encoded 16-bit instruction set. The re-encoded 16-bit instructions have smaller register and immediate fields, and the reduction in size is accomplished by encoding frequently used registers and immediate values.

For example, listed in Table 4 below, re-encodings for frequently used legacy instructions are shown with smaller register and immediate fields corresponding to frequently used registers and immediate values.

TABLE 4
16-Bit Re-encoding of Frequent MIPS32 Instructions

| | | Number | | Register | Total | Empty 0 | | |
|---|---|---|---|---|---|---|---|---|
| | Major | of | Immediate | Field | Size of | Field | Minor | |
| | Opcode | Register | Field Size | Width | Other | Size | Opcode | |
| Instruction | Name | Fields | (bit) | (bit) | Fields | (bit) | Size (bit) | Comment |
| ADDIUS5 | POOL16D | 5 bit: 1 | 4 | 5 | | 0 | 1 | Add |
| | | | | | | | | Immediate |
| | | | | | | | | Unsigned |
| | | | | | | | | Word Same |
| | | | | | | | | Register |
| ADDIUSP | POOL16D | 0 | 9 | 0 | | 0 | 1 | Add |
| | | | | | | | | Immediate |
| | | | | | | | | Unsigned |
| | | | | | | | | Word to Stack |
| | | | | | | | | Pointer |
| ADDIUR2 | POOL16E | 2 | 3 | 3 | | 0 | 1 | Add |
| | | | | | | | | Immediate |
| | | | | | | | | Unsigned |
| | | | | | | | | Word Two |
| | | | | | | | | Registers |
| ADDIUR1SP | POOL16E | 1 | 6 | 3 | | 0 | 1 | Add |
| | | | | | | | | Immediate |
| | | | | | | | | Unsigned |
| | | | | | | | | Word One |
| | | | | | | | | Registers and |
| | | | | | | | | Stack Pointer |
| ADDU16 | POOL16A | 3 | 0 | 3 | | 0 | 1 | Add Unsigned |
| | | | | | | | | Word |
| AND16 | POOL16C | 2 | 0 | 3 | | 0 | 4 | AND |
| ANDI16 | ANDI16 | 2 | 4 | 3 | | 0 | 0 | AND |
| | | | | | | | | Immediate |
| B16 | B16 | 0 | 10 | | | 0 | 0 | Branch |
| BREAK16 | POOL16C | 0 | 0 | | 4 | 0 | 6 | Cause |
| | | | | | | | | Breakpoint |
| | | | | | | | | Exception |
| JALR16 | POOL16C | 1 | 0 | 5 | | 0 | 5 | Jump and Link |
| | | | | | | | | Register, 32- |
| | | | | | | | | bit delay-slot |
| JALRS16 | POOL16C | 1 | 0 | 5 | | 0 | 5 | Jump and Link |
| | | | | | | | | Register, 16- |
| | | | | | | | | bit delay-slot |
| JR16 | POOL16C | 1 | 0 | 5 | | 0 | 5 | Jump Register |
| LBU16 | LBU16 | 2 | 4 | 3 | | 0 | 0 | Load Byte |
| | | | | | | | | Unsigned |
| LHU16 | LHU16 | 2 | 4 | 3 | | 0 | 0 | Load Halfword |
| LI16 | LI16 | 1 | 7 | 3 | | 0 | 0 | Load |
| | | | | | | | | Immediate |
| LW16 | LW16 | 2 | 4 | 3 | | 0 | 0 | Load Word |
| LWGP | LWGP16 | 1 | 7 | 3 | | 0 | 0 | Load Word GP |
| LWSP | LWSP16 | 5 bit: 1 | 5 | 5 | | 0 | 0 | Load Word SP |
| MFHI16 | POOL16C | 1 | 0 | 5 | | 0 | 5 | Move from HI |
| | | | | | | | | Register |
| MFLO16 | POOL16C | 1 | 0 | 5 | | 0 | 5 | Move from LO |
| | | | | | | | | Register |
| MOVE16 | MOVE16 | 2 | 0 | 5 | | 0 | 0 | Move |
| NOT16 | POOL16C | 2 | 0 | 3 | | 0 | 4 | NOT |
| OR16 | POOL16C | 2 | 0 | 3 | | 0 | 4 | OR |
| SB16 | SB16 | 2 | 4 | 3 | | 0 | 0 | Store Byte |
| SDBBP16 | POOL16C | 0 | 0 | | 4 | 0 | 6 | Cause Debug |
| | | | | | | | | Breakpoint |
| | | | | | | | | Exception |
| SH16 | SH16 | 2 | 4 | 3 | | 0 | 0 | Store Halfword |
| SLL16 | POOL16B | 2 | 3 | 3 | | 0 | 1 | Shift Word |
| | | | | | | | | Left Logical |
| SRL16 | POOL16B | 2 | 3 | 3 | | 0 | 1 | Shift Word |
| | | | | | | | | Right Logical |
| SUBU16 | POOL16A | 3 | 0 | 3 | | 0 | 1 | Sub Unsigned |
| SW16 | SW16 | 2 | 4 | 3 | | 0 | 0 | Store Word |
| SWSP | SWSP16 | 5 bit: 1 | 5 | 5 | | 0 | 0 | Store Word SP |
| XOR16 | POOL16C | 2 | 0 | 3 | | 0 | 4 | XOR |

TABLE 5
Instruction-Specific Register Specifiers and Immediate Field Values

| | Number | | | | | |
|---|---|---|---|---|---|---|
| | of | Immediate | Register 1 | Register 2 | Register 3 | |
| | Register | Field Size | Decoded | Decoded | Decoded | Immediate Field Decoded |
| Instruction | Fields | (bit) | Value | Value | Value | Value |
| ADDIUS5 | 5 bit: 1 | 4 | rd: 5 bit field | | | −8 . . . 0 . . . 7 |
| ADDIUSP | 0 | 9 | | | | (−258 . . . −3, 2 . . . 257) << 2 |
| ADDIUR2 | 2 | 3 | rs1: 2-7, 16, 17 | rd: 2-7, 16, 17 | | −1, 1, 4, 8, 12, 16, 20, 24 |
| ADDIUR1SP | 1 | 6 | rd: 2-7, 16, 17 | | | (0 . . . 63) << 2 |
| ADDU16 | 3 | 0 | rs1: 2-7, 16, 17 | rs2: 2-7, 16, 17 | rd: 2-7, 16, 17 | |
| AND16 | 2 | 0 | rs1: 2-7, 16, 17 | rd: 2-7, 16, 17 | | |
| ANDI16 | 2 | 4 | rs1: 2-7, 16, 17 | rd: 2-7, 16, 17 | | 1, 2, 3, 4, 7, 8, 15, 16, 31, 32, |
| | | | | | | 63, 64, 128, 255, 32768, 65535 |
| B16 | 0 | 10 | | | | (−512 . . . 511) << 1 |
| BEQZ16 | 1 | 7 | rs1: 2-7, 16, 17 | | | (−64 . . . 63) << 1 |
| BNEZ16 | 1 | 7 | rs1: 2-7, 16, 17 | | | (−64 . . . 63) << 1 |
| BREAK16 | 0 | 4 | | | | 0 . . . 15 |
| JALR16 | 5 bit: 1 | 0 | rs1: 5 bit field | | | |
| JALRS16 | 5 bit: 1 | 0 | rs1: 5 bit field | | | |
| JRADDIUSP | 0 | 5 | | | | (0 . . . 31) << 2 |
| JR16 | 5 bit: 1 | 0 | rs1: 5 bit field | | | |
| JRC | 5 bit: 1 | 0 | rs1: 5 bit field | | | |
| LBU16 | 2 | 4 | rb: 2-7, 16, 17 | rd: 2-7, 16, 17 | | −1, 0 . . . 14 |
| LHU16 | 2 | 4 | rb: 2-7, 16, 17 | rd: 2-7, 16, 17 | | (0 . . . 15) << 1 |
| LI16 | 1 | 7 | rd: 2-7, 16, 17 | | | −1, 0 . . . 126 |
| LW16 | 2 | 4 | rb: 2-7, 16, 17 | rd: 2-7, 16, 17 | | (0 . . . 15) << 2 |
| LWM16 | 2 bit list: 1 | 4 | | | | (0 . . . 15) << 2 |
| LWGP | 1 | 7 | rd: 2-7, 16, 17 | | | (−64 . . . 63) << 2 |
| LWSP | 5 bit: 1 | 5 | rd: 5-bit field | | | (0 . . . 31) << 2 |
| MFHI16 | 5 bit: 1 | 0 | rd: 5-bit field | | | |
| MFLO16 | 5 bit: 1 | 0 | rd: 5-bit field | | | |
| MOVE16 | 5 bit: 2 | 0 | rd: 5-bit field | rs1: 5-bit field | | |
| MOVEP | 3 | 0 | rd, re: | rt: 0, 2, 7, 16-20 | rs: 0, 2, 7, 16-20 | |
| | | | (5, 6), (5, 7), (6, 7), | | | |
| | | | (4, 21), (4, 22), | | | |
| | | | (4, | | | |
| | | | 5), (4, 6), (4, 7) | | | |
| NOT16 | 2 | 0 | rs1: 2-7, 16, 17 | rd: 2-7, 16, 17 | | |
| OR16 | 2 | 0 | rs1: 2-7, 16, 17 | rd: 2-7, 16, 17 | | |
| SB16 | 2 | 4 | rb: 2-7, 16, 17 | rs1: 0, 2-7, 17 | | 0 . . . 15 |
| SDBBP16 | 0 | 0 | | | | 0 . . . 15 |
| SH16 | 2 | 4 | rb: 2-7, 16, 17 | rs1: 0, 2-7, 17 | | (0 . . . 15) << 1 |
| SLL16 | 2 | 3 | rs1: 2-7, 16, 17 | rd: 2-7, 16, 17 | | 1 . . . 8 (see encoding tables) |
| SRL16 | 2 | 3 | rs1: 2-7, 16, 17 | rd: 2-7, 16, 17 | | 1 . . . 8 (see encoding tables) |
| SUBU16 | 3 | 0 | rs1: 2-7, 16, 17 | rs2: 2-7, 16, 17 | rd: 2-7, 16, 17 | |
| SW16 | 2 | 4 | rb: 2-7, 16, 17 | rs1: 0, 2-7, 17 | | (0 . . . 15) << 2 |
| SWSP | 5 bit: 1 | 5 | rs1: 5 bit field | | | (0 . . . 31) << 2 |
| SWM16 | 2 bit list: 1 | 4 | | | | (0 . . . 15) << 2 |
| XOR16 | 2 | 0 | rs1: 2-7, 16, 17 | rd: 2-7, 16, 17 | | |

In an embodiment, there are four variants of the ADDIU instruction. The first variant of the ADDIU instruction has a larger immediate field and only one register field. In the first variant of the ADDIU instruction, the register field represents a source as well as a destination. The second variant the ADDIU instruction has a smaller immediate field, but two register fields. The third variant, ADDIUSP, doesn't have source register encoding bit, using a single register (GPR29) as both the source and the target of the instruction, and using increments and decrements that are multiples of 4. The fourth variant, ADDIUR1SP, uses SP as the source register and has one three bit field to select the target register, such instruction using the remaining encoding bits to encode an increment, which is a multiple of 4.

Misalignment may occasionally result with the use of 16-bit instructions. To address this misalignment and to align instructions on a 32-bit boundary in specific cases, a 16-bit NOP instruction is provided in an embodiment described herein. The 16-bit NOP instruction may reduce code size as well.

The NOP instruction is not shown in the table because in the exemplary embodiment, the NOP instruction is implemented as a macro. For example, in one embodiment, the 16-bit NOP instruction is implemented as “MOVE16 r0, r0.”

In an embodiment, the compact instruction JRC is preferred over the JR instruction when the jump delay slot after JR cannot be filled. Because the JRC instruction may execute as fast as JR with a NOP in the delay slot, the JR instruction should be used if the delay slot can be filled.

Also, in an embodiment, the breakpoint instructions BREAK and SDBBP include a 16-bit variant. This allows a breakpoint to be inserted at any instruction address without overwriting more than a single instruction.

e. New ISA Instructions

As noted above, several new instructions are provided in the new ISA according to an embodiment. The new instructions and their formats for one embodiment are summarized in Table 6.

FIGS. 3A-Z, 4A-H and 5A-L are flowcharts describing the formats and operation of the instructions summarized in tables 6 and some of the instructions summarized on Table 4. The following sections provide the format, purpose, description, restrictions, operation, exceptions, and programming notes for an exemplary embodiment of each instruction.

TABLE 6
New Instructions - 32-Bit

| | | | | Total | | | | |
|---|---|---|---|---|---|---|---|---|
| | Number | | | Size | Empty 0 | Minor | | |
| | of | Immediate | | of | Field | Opcode | Major | |
| | Register | Field Size | Other | Other | Size | Size | Opcode | |
| Instruction | Fields | (bits) | Fields | Fields | (bits) | (bits) | Name | Comment |
| BEQZC | 1: 5-bit | 16 | | | 0 | 0 | POOL32I | Branch on |
| | | | | | | | | Equal to |
| | | | | | | | | Zero, |
| | | | | | | | | Compact |
| BNEZC | 1 | 16 | | 0 | 0 | 5 | POOL32I | Branch |
| | | | | | | | | Not Equal |
| | | | | | | | | Zero |
| | | | | | | | | Compact |
| JALX | 0 | 26 | 0 | 0 | 0 | 0 | JALX | JAL and |
| | | | | | | | | ISA mode |
| | | | | | | | | switch |
| LWP | 2: 5-bit | 12 | | | | 4 | POOL32B | Load |
| | | | | | | | | Word Pair |
| LWM | 1: 5-bit | 12 | reglist | 5 | 0 | 4 | POOL32B | Load |
| | | | | | | | | Word |
| | | | | | | | | Multiple |
| SWP | 2: 5-bit | 12 | | | | 4 | POOL32B | Store |
| | | | | | | | | Word Pair |
| SWM | 1: 5-bit | 12 | reglist | 5 | 0 | 4 | POOL32B | Store |
| | | | | | | | | Word |
| | | | | | | | | Multiple |
| ADDIUPC | 1 | 23 | | | 0 | 0 | ADDIUPC | Add |
| | | | | | | | | Immediate |
| | | | | | | | | Unsigned |
| | | | | | | | | Word |
| | | | | | | | | (PC- |
| | | | | | | | | Relative) |
| BGEZALS | 1: 5-bit | 16 | | | | 5 | POOL32I | Branch on |
| | | | | | | | | Greater |
| | | | | | | | | Than or |
| | | | | | | | | Equal to |
| | | | | | | | | Zero |
| | | | | | | | | and Link, |
| | | | | | | | | Short |
| | | | | | | | | Delay-Slot |
| BLTZALS | 1: 5-bit | 16 | | | | 5 | POOL32I | Branch on |
| | | | | | | | | Less Than |
| | | | | | | | | Zero and |
| | | | | | | | | Link, |
| | | | | | | | | Short |
| | | | | | | | | Delay-Slot |
| JALRS | 2: 5-bit | 0 | | | | 16 | POOL32A | Jump and |
| | | | | | | | | Link |
| | | | | | | | | Register, |
| | | | | | | | | Short |
| | | | | | | | | Delay Slot |
| JALRS.HB | 2: 5-bit | 0 | | | | 16 | POOL32A | Jump and |
| | | | | | | | | Link |
| | | | | | | | | Register |
| | | | | | | | | with |
| | | | | | | | | Hazard |
| | | | | | | | | Barrier, |
| | | | | | | | | Short |
| | | | | | | | | Delay-Slot |
| JALS | | 26 | | | | 0 | JALS | Jump and |
| | | | | | | | | Link, |
| | | | | | | | | Short |
| | | | | | | | | Delay Slot |

FIG. 3A is a schematic diagram illustrating the format for a Compact Branch on Equal to Zero (BEQZC) instruction according to an embodiment of the present invention. For coding, the format of the BEQZC instruction is “BEQZC rs, offset,” where rs is a general purpose register and offset is an immediate value offset. The purpose of the BEQZC instruction is to test a GPR. If the value of the GPR is zero (0), the processor performs a PC-relative conditional branch. That is, if (GPR[rs]=0) then branch to the effective target address.

FIG. 3B is a flowchart illustrating operation of a BEQZC instruction in a microprocessor according to an embodiment. In step 302, a register (rs) and offset are obtained. In step 304, the offset is shifted left by one bit. In step 306, the offset is sign extended, if necessary. In step 308, the offset is added to the address of the instruction after the branch to form the target address. In step 310, if the contents of GPR rs equal zero then, in step 312, the program branches to a the target address with no delay slot instruction, otherwise the instruction processing ends in step 313.

Pseudocode describing the above operation is provided as follows:

| | |
|---|---|
| I: | tgt_offset ← sign_extend(offset \|\| 0) |
| | condition ← (GPR[rs] = 0^{GPRLEN}) |
| | if condition then |
| | PC ← ( PC + 4 ) + tgt_offset |
| | endif |

In an embodiment, processor operation is unpredictable if the BEQZC instruction is placed in a delay slot of a branch or jump. In an embodiment, the BEQZC instruction has no exceptions. In an embodiment, BEQZC does not have a delay slot.

FIG. 3C is a schematic diagram showing a Compact Branch on Not Equal to Zero (BNEZC) instruction according to an embodiment of the present invention. For coding, the format of the BEQZC instruction is “BNEZC rs, offset,” where rs is a general purpose register and offset is an immediate value offset. The purpose of the BNEZC instruction is to test a GPR. If the value of the GPR is not zero (0), the processor performs a PC-relative conditional branch. That is, if (GPR[rs]≠0) then branch.

FIG. 3D is a flowchart illustrating the operation of a BNEZC instruction in a microprocessor according to an embodiment. In step 314, a register (rs) and offset are obtained. In step 316, the offset is then shifted left by one bit and in step 318, the offset operand is sign extended, if necessary. In step 320, the offset is added to the address of the instruction after the branch to form the target address. In step 322, if the contents of GPR rs is not equal to zero then, in step 324, the program branches to the target address with no delay slot instruction, otherwise the instruction processing ends in step 325.

Pseudocode describing the above operation is provided as follows:

| | |
|---|---|
| I: | tgt_offset ← sign_extend(offset \|\| 0) |
| | condition ← (GPR[rs] ≠ 0^{GPRLEN}) |
| | if condition then |
| | PC ← (PC + 4) + tgt_offset |
| | endif |

In an embodiment, processor operation is unpredictable if the BNEZC instruction is placed in a delay slot of a branch or jump. The BNEZC instruction has no exceptions. In an embodiment, the BNEZC does not have a delay slot.

FIG. 3E is a schematic diagram showing the format for a Jump and Link Exchange (JALX) instruction according to an embodiment of the present invention. For coding, the format of the JALX instruction is “JALX target” where target is a field to be used in calculating an effective target address for the instruction. The purpose of the JALX instruction is to execute a procedure call and change the ISA Mode, for example from a smaller bit-width instructions set to a larger bit-width instruction set.

FIG. 3F is a flowchart illustrating operation of a JALX instruction in a microprocessor according to an embodiment. In step 326, a target field is obtained. In step 328, a return link address is determined as the address of the next instruction following the branch delay slot instruction, where execution continues upon return from the procedure call. In step 330, the return address link is placed in GPR 31. Any GPR can be used for storing the return address link so long as it does not interfere with software execution. The value stored in GPR 31 bit 0 is set to the current value of the ISA Mode bit in step 331. In an embodiment, the ISA Mode bit represents which instruction set is currently being used to interpret a particular instruction (either the original ISA or the recoded ISA). In an embodiment, setting bit 0 of GPR 31 comprises concatenating the value of the ISA Mode bit to the upper 31 bits of the address of the next instruction following the branch delay slot instruction.

In an embodiment, the JALX instruction is a PC-region branch, not a PC-relative branch. That is, the effective target address is the “current” 256 MB-aligned region determined as follows. In step 332, the lower 28 bits of the effective target address are obtained by shifting the target field left by 2 bits. In an embodiment, this shift is accomplished by concatenating 2 zeros to the target field value. The remaining upper bits of the effective target address are the corresponding bits of the address of the instruction following the branch (not of the branch itself). In step 336, jumping to the effective target address is performed along with toggling the ISA Mode bit. The operation ends in step 338.

In an embodiment, the JALX instruction has no exceptions. In an embodiment, the effective target address is formed by adding a signed relative offset to the value of the PC. However, forming the jump target address by concatenating the PC and the shifted 26-bit target field rather than adding a signed offset is advantageous if all program code addresses will fit into a 256 MB region aligned on a 256 MB boundary. Using the concatenated PC and 26-bit target address allows a jump to anywhere in the region from anywhere in the region, which a signed relative offset would not allow.

Pseudocode describing the above operation is provided as follows:

| | |
|---|---|
| I: | GPR[31] ← (PC + 8) _{GPRLEN-1..1} \|\| ISAMode |
| I+1: | PC ← PC_{GPRLEN-1...28} \|\| target \|\| 0² |
| | ISAMode ← (not ISAMode) |

FIG. 3G is a schematic diagram showing the format of a second embodiment of the JALX instruction. JALX 32-bit mode instruction according to an embodiment of the present invention. For coding, the format of the JALX 32-bit instruction is “JALX instr_index” where instr_index is a field to be used in calculating an effective target address for the instruction. The purpose of the JALX 32-bit instruction is to execute a procedure call and change the ISA Mode, for example from a larger bit-width instruction set to a smaller bit-width instruction set.

FIG. 3H is a flowchart illustrating operation of the JALX instruction according to a second embodiment. In step 340, an instr_index field is obtained. In step 342, a return link address is determined as the address of the next instruction following the branch, where execution continues upon return from the procedure call. In step 344, the return address link in is placed in GPR 31. Any GPR can be used for storing the return address link so long as it does not interfere with software execution. The value stored in GPR 31 bit 0 is set to the current value of the ISA Mode bit in step 345. In an embodiment, setting bit 0 of GPR 31 comprises concatenating the value of the ISA Mode bit to the upper 31 bits of the address of the next instruction following the branch.

In an embodiment, the JALX instruction is a PC-region branch, not a PC-relative branch. That is, the effective target address is the “current” 256 MB-aligned region determined as follows. In step 346, the effective target address is determined by shifting the instr index field left by 2 bits. In an embodiment, this shift is accomplished by concatenating 2 zeros to the target field value. The remaining upper bits of the effective target address are the corresponding bits of the address of the second instruction following the branch (not of the branch itself). In step 350, the instruction in the delay slot is executed. In step 352, jumping to the effective target address is performed along with toggling the ISA Mode bit. The operation ends in step 354.

In an embodiment, the second embodiment of the JALX instruction has no restrictions and no exceptions. In an embodiment, the effective target address is formed by adding a signed relative offset to the value of the PC. However, forming the jump target address by concatenating the PC and the shifted 26-bit target field rather than adding a signed offset is advantageous if all program code addresses will fit into a 256 MB region aligned on a 256 MB boundary. Using the concatenated PC and 26-bit target address allows a jump to anywhere in the region from anywhere in the region, which a signed relative offset would not allow.

In an embodiment, the second embodiment of the JALX instruction supports only 32-bit aligned branch target addresses. In an embodiment, processor operation is unpredictable if a branch, jump, ERET, DERET, or WAIT instruction is placed in the delay slot of a branch or jump. In an embodiment, the JALX 32-bit instruction has no exceptions.

Pseudocode describing the above operation is provided as follows:

| | |
|---|---|
| I: | GPR[31] ← (PC + 8) \|\| ISAMode |
| I+1: | PC ← PC_{GPRLEN-1...28} \|\| instr_index \|\| 0² |
| | ISAMode ← (not ISAMode) |

FIG. 3I is a schematic diagram showing the format for a Compact Jump Register (JRC) instruction according to an embodiment of the present invention. For coding, the format of the JRC instruction is JRC rs, where rs is a general purpose register. The purpose of the JRC instruction is to execute a branch to an instruction address in a register. That is, PC←GPR [rs].

FIG. 3J is a flowchart illustrating operation of a JRC instruction in a microprocessor according to an embodiment. In step 356, an address held in register (rs) is obtained. In step 358, the program unconditionally jumps to the address specified in GPR rs, and the ISA Mode bit is set to the value in GPR rs bit 0. In an embodiment, there is no delay slot instruction. The operation ends in step 360.

In an embodiment, bit 0 of the target address is always zero (0). Because of this, no address exceptions occur when bit 0 of the source register is one (1). In an embodiment, the effective target address in GPR rs must be 32-bit aligned. If bit 0 of GPR rs is zero and bit 1 of GPR rs is one, then an Address Error exception occurs when the jump target is subsequently fetched as an instruction. The JRC instruction has no exceptions.

Pseudocode describing the above operation is provided as follows:

| | |
|---|---|
| I: | PC ← GPR [rs]_{GPRLEN-1..1 \|\| 0} |
| | ISAMode ← GPR [rs]₀ |

FIG. 3K is schematic diagram showing the format for a Load Word Pair (LWP) instruction according to an embodiment of the present invention. In an embodiment, the purpose of the LWP instruction is to load two consecutive words from memory. That is, GPR[rd], GPR[rd+1]←memory[GPR[base]+offset]. For coding, the format of the LWP instruction is “LWP rd, offset (base),” where rd is the first register of the target register pair, base is the register holding the base address to which offset is added to determine the effective address in memory from which to obtain data to be loaded, and offset is an immediate value.

FIG. 3L is a flowchart illustrating operation of an LWP instruction according to an embodiment. In step 368, register (rd), register (base) and offset are obtained. In step 369, GPR(base) is added to offset to form the effective address. In step 370, the contents of the memory location specified by the 32-bit aligned effective address is loaded. In step 371, the loaded word is sign-extended to the GPR register width if necessary. In step 372, the first retrieved word is stored in GPR rd. In step 373, the effective address of the second word to be stored is determined by adding GPR(base) to offset+4. In step 374, the contents of the memory location specified by the newly determined effective address are retrieved as the second loaded word. In step 375, the second loaded word is sign-extended to the GPR register width if necessary. In 376, the second memory word is stored in GPR(rd+1). The operation ends in step 377.

In an embodiment, the effective address must be 32-bit aligned. If either of the 2 least-significant bits of the address is non-zero, an Address Error exception occurs. In an embodiment, the behavior of the instructions is architecturally undefined if rd equals GPR 31. The behavior of the LWP instruction is also architecturally undefined, if base and rd are the same. This allows the LWP operation to be restarted if an interrupt or exception aborts the operation in the middle of execution. In an embodiment, the behavior of this instruction is also architecturally undefined, if it is placed in a delay slot of a jump or branch. In an embodiment, the LWP exceptions are: TLB Refill, TLB Invalid, Bus Error, Address Error, and Watch.

Pseudocode describing the above operation is provided as follows:

vAddr ← sign_extend(offset) + GPR[base]
if vAddr_{1...0} ≠ 0² then
Signal Exception(AddressError)
endif
(pAddr, CCA) ← AddressTranslation (vAddr,
DATA, LOAD)
memword ← LoadMemory (CCA, WORD, pAddr,
vAddr, DATA)
GPR[rd] ← memword
vAddr ← sign_extend(offset) + GPR[base] + 4
(pAddr, CCA) ← AddressTranslation (vAddr,
DATA, LOAD)
memword ← LoadMemory (CCA, WORD, pAddr,
vAddr, DATA)
GPR [rd+1] ← memword

In an embodiment, the LWP instruction may execute for a variable number of cycles and may perform a variable number of loads from memory. Further, in an embodiment, a full restart of the sequence of operations will be performed on return from any exception taken during execution.

FIG. 3M is a schematic diagram showing the format for a Load Word Multiple (LWM) instruction according to an embodiment of the present invention. For coding, the format of the LWM instruction is “LWM reglist, (base),” where reglist is a bit field wherein each bit corresponds to a different register.

In another embodiment, reglist is an encoded bit field with each encoded value mapping to a subset of the available registers. In yet another embodiment, reglist identifies a register that contains a bit field in which each bit corresponds to a different register. The purpose of the LWM instruction is to load a sequence of consecutive words from memory. That is, GPR[reglist[m]] . . . GPR[reglist[n]]←memory[GPR[base]] . . . memory[GPR[base]+4*(n−m)]. Table 7 shows an example of reglist encoding, according to embodiments.

TABLE 7
Example Reglist Encoding

| reglist Encoding | |
|---|---|
| (binary) | List of Registers Loaded |
| 0 0 0 0 1 | GPR[16] |
| 0 0 0 1 0 | GPR[16], GPR[17] |
| 0 0 0 1 1 | GPR[16], GPR[17], GPR[18] |
| 0 0 1 0 0 | GPR[16], GPR[17], GPR[18], GPR[19] |
| 0 0 1 0 1 | GPR[16], GPR[17], GPR[18], GPR[19], GPR[20] |
| 0 0 1 1 0 | GPR[16], GPR[17], GPR[18], GPR[19], GPR[20], GPR[21] |
| 0 0 1 1 1 | GPR[16], GPR[17], GPR[18], GPR[19], GPR[20], GPR[21], GPR[22] |
| 0 1 0 0 0 | GPR[16], GPR[17], GPR[18], GPR[19], GPR[20], GPR[21], GPR[22], GPR[23] |
| 0 1 0 0 1 | GPR[16], GPR[17], GPR[18], GPR[19], GPR[20], GPR[21], GPR[22], GPR[23], GPR[30] |
| 1 0 0 0 0 | GPR[31] |
| 1 0 0 0 1 | GPR[16], GPR[31] |
| 1 0 0 1 0 | GPR[16], GPR[17], GPR[31] |
| 1 0 0 1 1 | GPR[16], GPR[17], GPR[18], GPR[31] |
| 1 0 1 0 0 | GPR[16], GPR[17], GPR[18], GPR[19], GPR[31] |
| 1 0 1 0 1 | GPR[16], GPR[17], GPR[18], GPR[19], GPR[20], GPR[31] |
| 1 0 1 1 0 | GPR[16], GPR[17], GPR[18], GPR[19], GPR[20], GPR[21], GPR[31] |
| 1 0 1 1 1 | GPR[16], GPR[17], GPR[18], GPR[19], GPR[20], GPR[21], GPR[22], GPR[31] |
| 1 1 0 0 0 | GPR[16], GPR[17], GPR[18], GPR[19], GPR[20], GPR[21], GPR[22], GPR[23], GPR[31] |
| 1 1 0 0 1 | GPR[16], GPR[17], GPR[18], GPR[19], GPR[20], GPR[21], GPR[22], GPR[23], GPR[30], GPR[31] |
| All other combinations | Reserved |

In embodiments of LWM, the contents of consecutive 32-bit words at the memory location specified by the 32-bit aligned effective address are fetched, sign-extended to the GPR register length if necessary, and placed in the GPRs defined by reglist. The 12-bit signed offset is added to the contents of GPR base to form the effective address.

FIG. 3N is a flowchart illustrating operation of the LWM instruction in a microprocessor according to an embodiment. In step 380, a register list (reglist), base and offset values are obtained. In step 381, an effective address is formed from the unsigned addition of the offset field of the instruction with the contents of GPR(base). In step 382, the content of the memory location specified by the 32-bit aligned effective address is fetched. In step 383, the retrieved word is sign-extended to the GPR register width if necessary. In step 384, the result is stored in the GPR corresponding to the next register identified in reglist. In step 385, the effective address is update to the next word to be loaded from memory. In step 386, steps 382 through 385 are repeated for each register value identified in reglist.

In an embodiment, the effective address must be 32-bit aligned. If either of the 2 least-significant bits of the address is non-zero, an address error exception occurs. The behavior of the LWM instruction is architecturally undefined if base is included in reglist. The behavior of the LWM instruction is also architecturally undefined, if base is included in reglist, this allowing an operation to be restarted if an interrupt or exception has aborted the operation in the middle of execution.

Pseudocode describing the above operation is provided as follows:

```
vAddr ← sign_extend(offset) + GPR[base]
if vAddr_{1..0} ≠ 0² then
    SignalException(AddressError)
endif
for i←0 to fn(reglist)
    (pAddr, CCA) ← AddressTranslation (vAddr, DATA, LOAD)
    memword ← LoadMemory (CCA, WORD, pAddr, vAddr, DATA)
    GPR[gpr(reglist,i)] ← memword
    vAddr ← vAddr + 4
endfor
function fn(list)
    fn ← (number of entries in list) − 1;
endfunction
```

In an embodiment, LWM exceptions are TLB Refill, TLB Invalid, Bus Error, Address Error, and Watch. In an embodiment, the LWM instruction executes for a variable number of cycles and performs a variable number of loads from memory. In an embodiment, a full restart of the sequence of operations is performed on return from any exception taken during execution.

FIG. 3O is a schematic diagram showing the format for a Store Word Pair (SWP) instruction according to an embodiment of the present invention. In an embodiment, the purpose of the SWP instruction is to store two consecutive words to memory. That is, memory[GPR[base]+offset]←GPR[rs1], GPR[rs1+1]. For coding, the format of the SWP instruction is “SWP rs1, offset(base),” where rs1 is the first register of the source register pair, base is the register holding the base address to which offset is added to determine the effective address in memory to which to store data, and offset is an immediate value.

FIG. 3P is a flowchart illustrating operation of an SWP instruction according to an embodiment. In step 387, the register (rs1), register (base), and offset are obtained. In step 388, GPR(base) is added to offset to form the effective address. In step 390, a first least-significant 32-bit word is obtained from GPR(rs1). In step 392, the obtained first retrieved 32-bit word is stored in memory at the location specified by the aligned effective address. In step 394, the effective address is updated as GPR(base)+offset+4 to address the next memory location in which to store data. The offset value is sign extended as required. In step 396, a second least-significant 32-bit word is obtained from GPR(rs1+1). In step 398, the obtained second 32-bit word is stored in memory at the location specified by the updated aligned effective address. The operation ends in step 399.

A restriction in an embodiment is that the effective address must be 32-bit aligned. If either of the 2 least-significant bits of the address are non-zero, an Address Error exception occurs. In an embodiment, the behavior of this instruction is architecturally undefined, if it is placed in a delay slot of a jump or branch.

In an embodiment, the SWP instruction may execute for a variable number of cycles and may perform a variable number of stores to memory. Further, in an embodiment, a full restart of the sequence of operations is performed on return from any exception taken during execution. In an embodiment, exceptions to the SWP instruction are TLB Refill, TLB Invalid, TLB Modified, Address Error and Watch.

Pseudocode describing the above operation is provided as follows:

vAddr ← sign_extend(offset) + GPR[base]
if vAddr_{1...0} ≠ 0² then
SignalException(AddressError)
endif
(pAddr, CCA) ← AddressTranslation (vAddr, DATA,
STORE)
dataword ← GPR[rs1]
StoreMemory (CCA, WORD, pAddr, vAddr, DATA)
vAddr ← sign_extend(offset) + GPR[base] + 4
(pAddr, CCA) ← AddressTranslation (vAddr, DATA,
STORE)
dataword ← GPR [rs1+1]
StoreMemory (CCA, WORD, dataword, pAddr, vAddr,
DATA)

FIG. 3Q is a schematic diagram showing the format for a Store Word Multiple (SWM) instruction according to an embodiment of the present invention. For coding, the format of the SWM instruction is “SWM reglist (base),” where reglist is a bit field wherein each bit corresponds to a different register. In another embodiment, reglist is an encoded bit field with each encoded value mapping to a subset of the available registers. In yet another embodiment, reglist identifies a register that contains a bit field in which each bit corresponds to a different register. The purpose of the SWM instruction is to store a sequence of consecutive words to memory. That is,

memory[GPR[base]].....memory[GPR[base]+4*[n−m]]←
GPR[reglist[m]]......[GPR[reglist[n]]

FIG. 3R is a flowchart illustrating operation of a SWM instruction according to an embodiment. In step 380a, a register list (reglist), base operand and offset operand are obtained. In step 381a, an effective address is formed using the contents of GPR(base)+sign_extend(offset). In step 382a, the least-significant 32-bit word of the next GPR identified by reglist is obtained. In step 383a, the obtained data is stored in memory at the address corresponding to the effective address. In step 384a, the effective address is updated to the next address for writing data in memory. In step 385a, steps 382a through 384a are repeated for each register identified in reglist.

In an embodiment, the restrictions on the SWM instruction are that the effective address must be 32-bit aligned. If either of the 2 least-significant bits of the address is non-zero, an address error exception occurs. In an embodiment, the behavior of this instruction is architecturally undefined, if it is placed in a delay slot of a jump or branch. In an embodiment, the SWM instruction executes for a variable number of cycles and performs a variable number of stores to memory. A full restart of the sequence of operations will be performed on return from any exception taken during execution. In an embodiment, exceptions to SWM are TLB Refill, TLB Invalid, TLB Modified, Address Error and Watch.

Pseudocode describing the above operation is provided as follows:

```
vAddr ← sign_extend(offset) + GPR[base]
if vAdd_{1..0} ≠ 0² then
    SignalException(AddressError)
endif
for i←0 to fn(reglist)
    (pAddr, CCA) ← AddressTranslation (vAddr, DATA, STORE)
    dataword ← GPR[fgpr(reglist,i)]
    StoreMemory (CCA, WORD, dataword, pAddr, vAddr, DATA)
    vAddr ← vAddr + 4
endfor
function fn(list)
    fn ← (number of entries in list) − 1;
endfunction
```

FIG. 4A is a schematic diagram showing the format for a Jump Register, Adjust the Stack Pointer (JRADDIUSP) instruction according to an embodiment of the present invention. In an embodiment, the purpose of the JRADDIUSP instruction is to execute a branch to an instruction address in a register and adjust a stack pointer. For coding, the format of the JRADDIUSP instruction is “JRADDIUSP immediate” where immediate is an immediate value argument to be decoded.

FIG. 4B is a flowchart illustrating operation of a JRADDIUSP instruction according to an embodiment. In step 402, the values stored in registers GPR29 and GPR31 and the immediate increment value are obtained. In step 404, the immediate increment value is left shifted by 2 bits and the result is zero extended. In step 406, the left shifted immediate value is added to the value from GPR29, and the result is placed in GPR29. In step 408 the effective target address is set to the value in GPR31 with Bit 0 cleared. In step 410, the current ISA Mode Bit is set to bit 0 of the value from GPR31. In step 412, a jump to the effective target address is performed. The operation ends at step 432.

In an embodiment, no Integer Overflow exception occurs under any circumstances for the update of GPR 29. In other embodiments, it is implementation-specific whether interrupts are disabled during the sequence of operations generated by this instruction.

In an embodiment, the JRADDIUSP instruction has no exceptions. In an embodiment, the restrictions on the JRADDIUSP instruction are that if bit 0 of GPR31 is zero to specify jumping to a MIPS32 target and bit 1 is of GPR31 is one, then an Address Error exception occurs when the jump target is subsequently fetched as an instruction. Another restriction in an embodiment is if ISA mode switching is not possible (e.g., MIPS32 is not implemented) then bit 0 of GPR31 must be set to one, and if bit 0 of GPR31 is zero, then an Address Error exception occurs when the jump target is subsequently fetched as an instruction. Also in an embodiment of JRADDIIUSP, unlike most MIPS “jump” instructions, the embodiment does not have a delay slot.

Pseudocode describing the above operation is provided as follows:

PC ← GPR[31]_{GPRLEN-1..1} || 0
if ( Config3_{ISA} > 1 )
ISAMode ← GPR[31]₀
endif
I+1:
temp ← GPR[29] + zero_extend(immediate || 0²)
GPR[29] ← temp

FIG. 4C is a schematic diagram showing the format for Add Immediate Unsigned Word 5-Bit Register Select (ADDIUS5) instruction according to an embodiment of the present invention. For coding, the format of the ADDIUS5 instruction is “ADDIUS5 rd, immediate_value” where rd is a general purpose register and immediate_value is an immediate value argument to be decoded.

In an embodiment, the purpose of the ADDIUS5 instruction is to add a constant to a 32-bit integer.

FIG. 4D is a flowchart illustrating operation of an ADDIUS5 instruction according to an embodiment. In step 422, a 4-bit instruction immediate value is obtained. In step 424, the 4-bit instruction immediate value is sign extended. In step 426, a 5-bit register index rd is obtained from the instruction. Table 8 shows an example of encoded and decoded values of the signed immediate field. In step 428, GPR(rd) is added to the sign extended immediate value. In step 430, the result of the addition is placed in GPR(rd). The operation ends at step 414.

In an embodiment, the ADDIUS5 instruction has no restrictions and no exceptions.

TABLE 8
Encoded and Decoded Values of Signed Immediate Field

| Encoded Value of | Encoded Value | Decoded Value | |
|---|---|---|---|
| Instr4 . . . 1 | of Instr4 . . .1 | of Immediate | Decoded Value of |
| (Decimal) | (Hex) | (Decimal) | Immediate (Hex) |
| 0 | 0x0 | 0 | 0x0000 |
| 1 | 0x1 | 1 | 0x0001 |
| 2 | 0x2 | 2 | 0x0002 |
| 3 | 0x3 | 3 | 0x0003 |
| 4 | 0x4 | 4 | 0x0004 |
| 5 | 0x5 | 5 | 0x0005 |
| 6 | 0x6 | 6 | 0x0006 |
| 7 | 0x7 | 7 | 0x0007 |
| 8 | 0x8 | −8 | 0xfff8 |
| 9 | 0x9 | −7 | 0xfff9 |
| 10 | 0xa | −6 | 0xfffa |
| 11 | 0xb | −5 | 0xfffb |
| 12 | 0xc | −4 | 0xfffc |
| 13 | 0xd | −3 | 0xffffd |
| 14 | 0xe | −2 | 0xfffe |
| 15 | 0xf | −1 | 0xffff |

Pseudocode describing the above operation is provided as follows:

Operation:
temp ← GPR[rd] + sign_extend(immediate)
GPR(rd) ← temp

In an embodiment, the ADDIUS5 operation uses 32-bit modulo arithmetic that does not trap on overflow. An embodiment can be used for unsigned arithmetic, such as address arithmetic, or integer arithmetic environments that ignore overflow, such as C language arithmetic.

FIG. 4E is a schematic diagram showing the format for Add Immediate Unsigned Word (PC-Relative) (ADDIUPC) instruction according to an embodiment of the present invention.

In an embodiment, the purpose of the ADDIUPC instruction is to write a register with a value that is the addition of a constant to the Program Counter value. For coding, the format of the ADDIUPC instruction is “ADDIUPC rs, left_shifted_where rs is a general purpose register and left_shifted_immediate is an immediate value argument to be left shifted.

FIG. 4F is a flowchart illustrating operation of an ADDIUPC instruction according to an embodiment. In step 442, a 23-bit instruction immediate value is obtained. In step 444, the 23-bit instruction immediate value is left shifted by 2 bits. In step 446, the left shifted 23-bit instruction immediate value is sign extended. In step 448, a 3-bit register index (rs) is obtained from the instruction. In step 450, the 3-bit register index (rs) is converted to decoded 5-bit register index (rs_decoded). In step 452, the program counter value is copied for the instruction. In step 454, bits 0 and 1 of the copied program counter value are cleared. In step 456, the copied program counter value is added to the sign extended immediate value. In 458, the result of addition is placed in GPR(rs_decoded). The operation ends at step 460.

In an embodiment, no integer overflow exception occurs under any circumstances. Unlike an implementation from an older 16-bit ISA version of this instruction, e.g., MIPS16e available from MIPS, INC. of Sunnyvale, Calif., in an embodiment, the program counter (PC) value of the ADDIUPC instruction is always used, even when the embodiment of the ADDIUPC instruction is placed in the delay-slot of a jump or branch instruction.

In an embodiment, the restrictions on the ADDIUPC instruction are that the 3-bit register field can only specify GPRs $2-$7, $16, $17. In an embodiment, the ADDIUPC instruction has no exceptions.

Pseudocode describing the above operation is provided as follows:

Operation:
temp ← (PC_{GPRLEN-1..2} || 0²) + sign_extend(immediate || 0²)
GPR[Xlat(rs)] ← temp

In an embodiment, the ADDIUPC operation uses 32-bit modulo arithmetic that does not trap on overflow. An embodiment can be used for unsigned arithmetic, such as address arithmetic, or integer arithmetic environments that ignore overflow, such as C language arithmetic.

FIG. 4G is a schematic diagram showing the format for a Move a Pair of Registers (MOVEP) instruction according to an embodiment of the present invention. For coding, the format of the MOVEP instruction is “MOVEP rd, re, rs, rt” where rd, re, rs and rt are general purpose registers.

In an embodiment, the purpose of the MOVEP instruction is to move a Pair of Registers, e.g., to copy two GPRs to another two GPRs. Description: GPR[rd]←GPR[rs]; GPR[re]←GPR[rt];

FIG. 4H is a flowchart illustrating operation of a MOVEP instruction according to an embodiment. In step 462, the 3-bit encoded register index Enc_rs and 3-bit encoded register index Enc_rt are obtained from the instruction. In step 464, the 3-bit encoded register index Enc_rs is converted to decoded 5-bit register index (rs). An example of the encoded values of Enc_rt and Enc_rs is shown in table 9. In step 466, the 3-bit encoded register index Enc_rt is converted to decoded 5-bit register index (rt). In step 468, the 3-bit dual destination register code Enc_dest is obtained from instruction. In step 470, the Enc_dest value is converted to 5-bit destination register indexes rd and re. An example of the decoding of Enc_dest is shown in Table 10. In step 472, the value of GPR(rs) is copied and placed in GPR(rd). In step 474, the value of GPR(rt) is copied and placed in GPR(re). The operation ends at step 476.

TABLE 9
Encoded and Decoded Values of the Enc_rs and Enc_rt Fields

| Encoded | Encoded | | |
|---|---|---|---|
| Value of | Value of | Decoded | |
| Instr6 . . . 4 (or | Instr6 . . . 4 (or | Value of rt | |
| inst 3 . . . 1) | inst 3 . . . 1) | (or rs) | Symbolic |
| (Decimal) | (Hex) | (Decimal) | Name |
| 0 | 0x0 | 0 | zero |
| 1 | 0x1 | 17 | s1 |
| 2 | 0x2 | 2 | v0 |
| 3 | 0x3 | 3 | v1 |
| 4 | 0x4 | 16 | s0 |
| 5 | 0x5 | 18 | s2 |
| 6 | 0x6 | 19 | s3 |
| 7 | 0x7 | 20 | s4 |

TABLE 10
Encoded and Decoded Values of the Enc_dest Field

| Encoded | Encoded | | |
|---|---|---|---|
| Value of | Value of | Decoded | Decoded |
| Instr9 . . . 7 | Instr9 . . . 7 | Value of rd | Value of re |
| (Decimal) | (Hex) | (Decimal) | (Decimal) |
| 0 | 0x0 | 5 | 6 |
| 1 | 0x1 | 5 | 7 |
| 2 | 0x2 | 6 | 7 |
| 3 | 0x3 | 4 | 21 |
| 4 | 0x4 | 4 | 22 |
| 5 | 0x5 | 4 | 5 |
| 6 | 0x6 | 4 | 6 |
| 7 | 0x7 | 4 | 7 |

In an embodiment, it is implementation-specific whether interrupts are disabled during the sequence of operations generated by this instruction.

In an embodiment, the restrictions on the MOVEP instruction are that the destination register pair field, Enc_dest, can only specify the register pairs defined in Table 10. The source register fields Enc_rs and Enc_rt can only specify GPRs 0, 2-3, 16-20. The behavior of this instruction is UNDEFINED, if it is placed in a delay slot of a jump or branch. In an embodiment, the MOVEP instruction has no exceptions. In an embodiment, the behavior of the MOVEP instruction is architecturally undefined, if it is placed in a delay slot of a jump or branch.

Pseudocode describing the above operation is provided as follows:

Operation:
GPR[rd] ← GPR[rs]; GPR[re] ← GPR[rt]

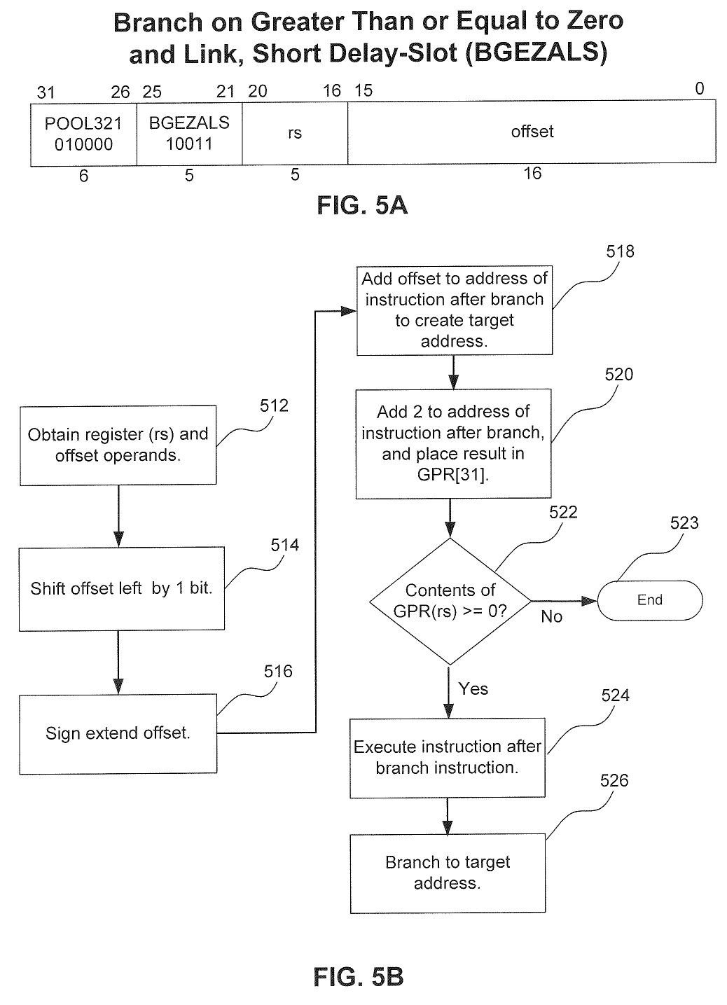

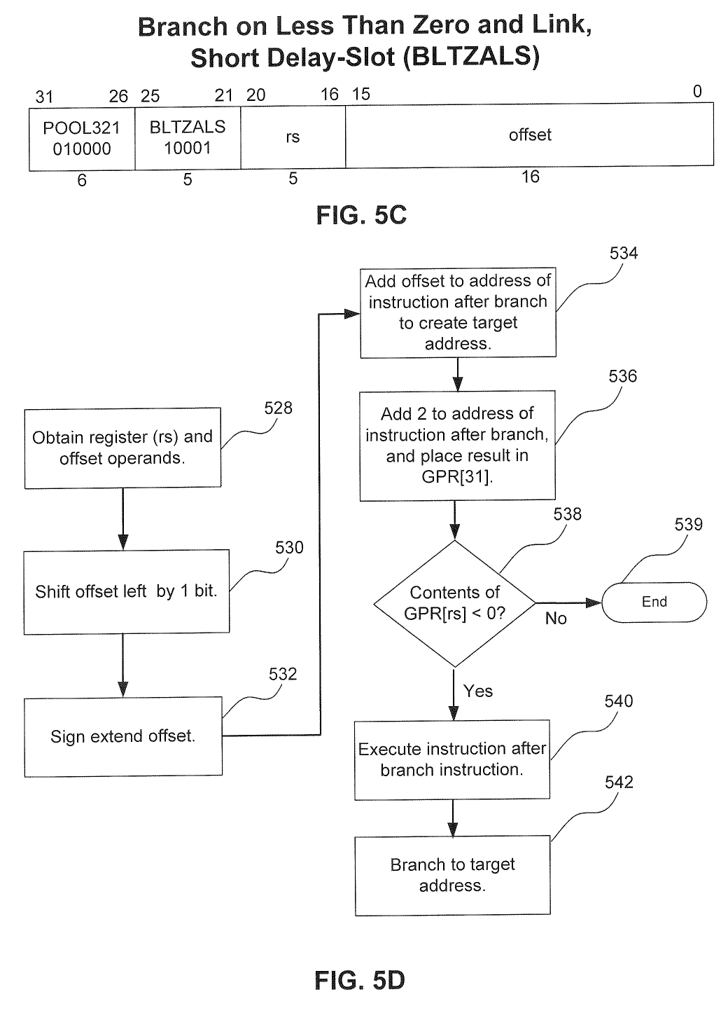

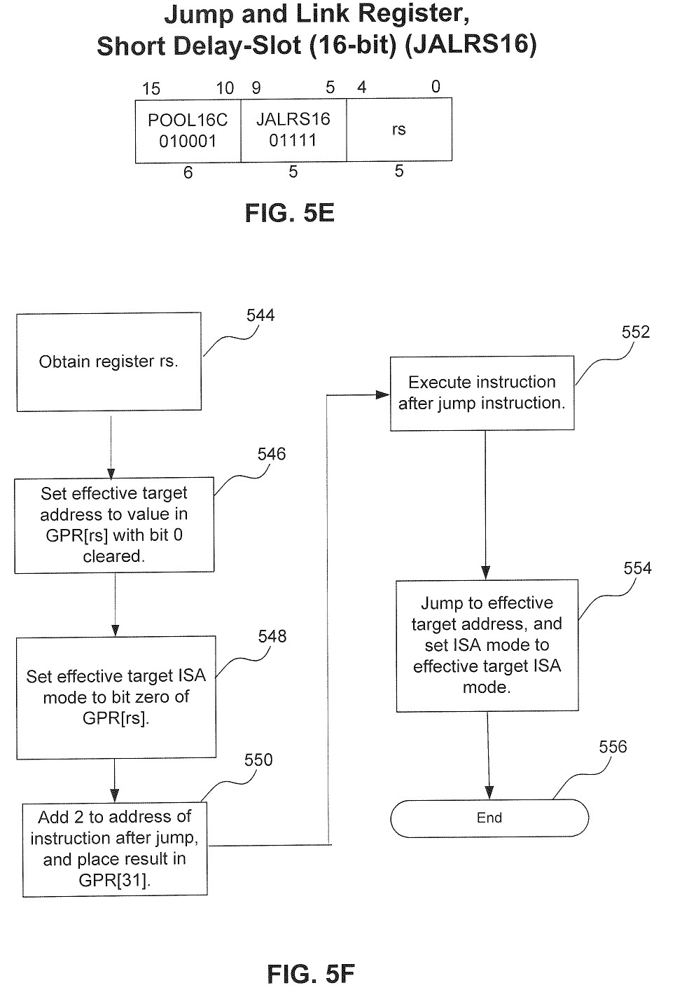

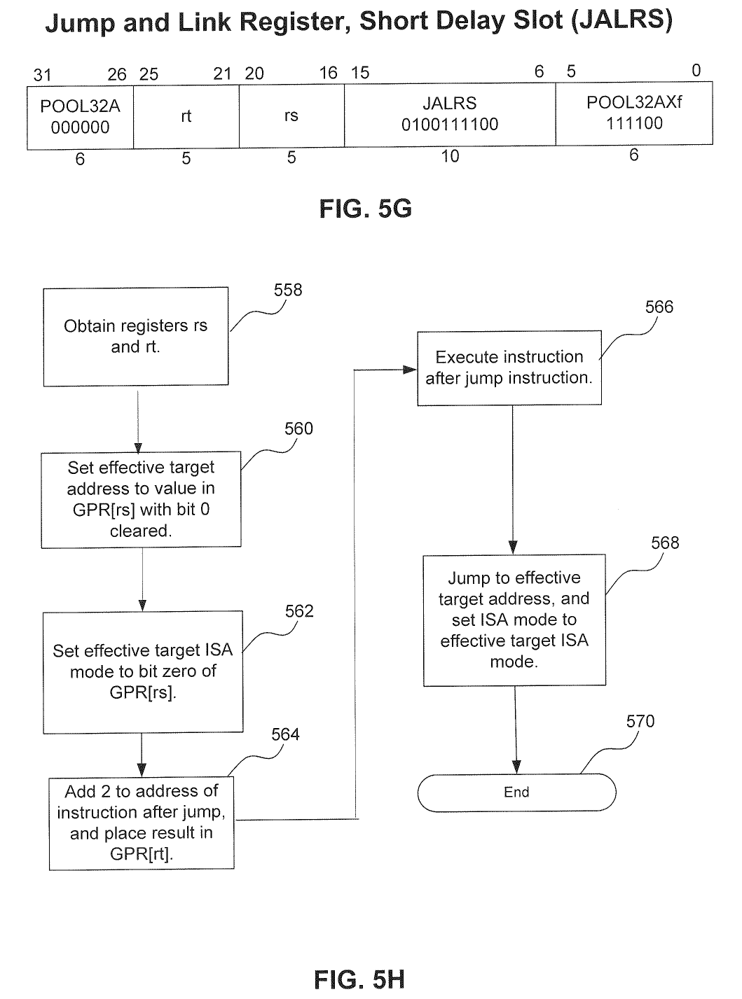

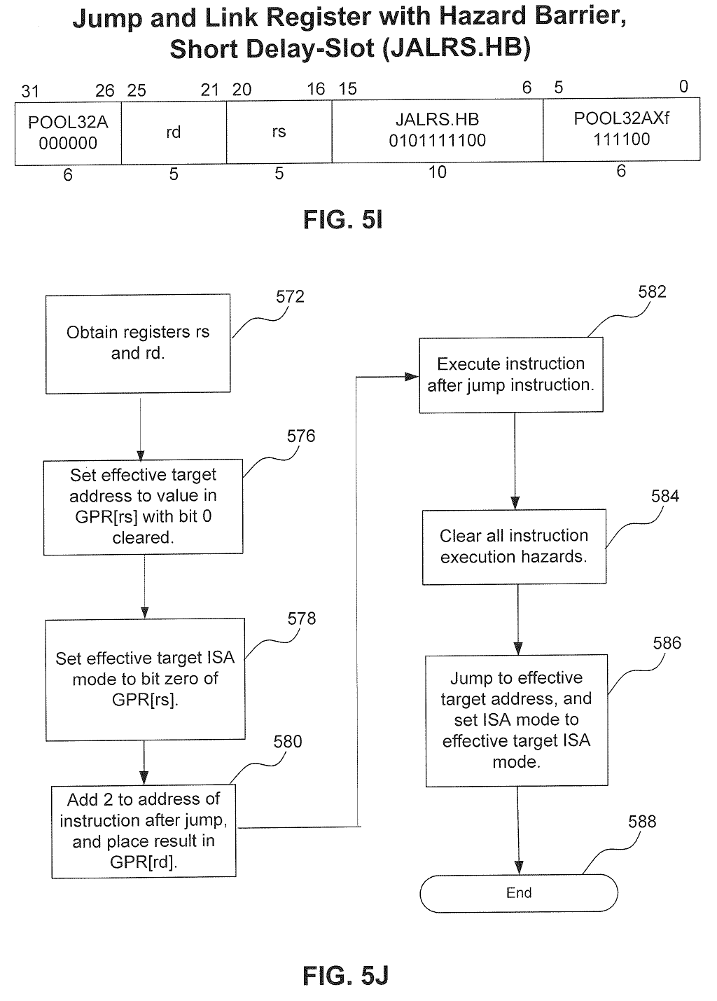

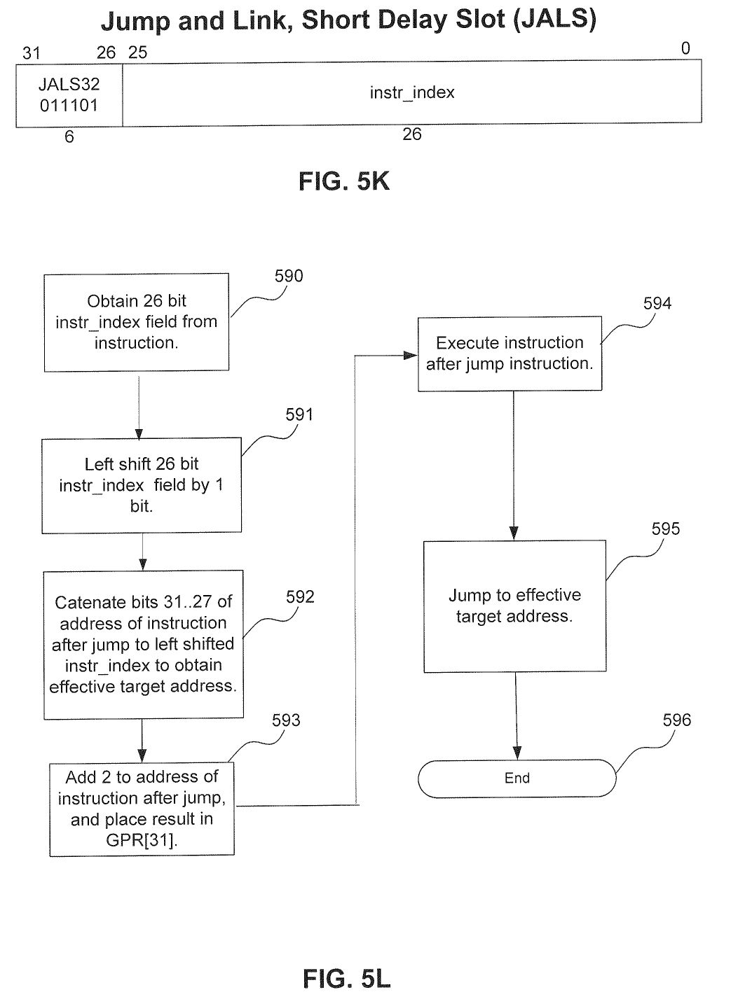

FIG. 5A is a schematic diagram showing the format for Branch on Greater Than or Equal to Zero and Link, Short Delay-Slot (BGEZALS) instruction according to an embodiment of the present invention. For coding, the format of the BGEZALS instruction is “BGEZALS rs, offset”.

In an embodiment, the purpose of the BGEZALS instruction is to test a GPR then do a PC-relative conditional procedure call, e.g., if GPR[rs]≧0 then procedure_call.

FIG. 5B is a flowchart illustrating operation of a BGEZALS instruction according to an embodiment. In step 512, the register (rs) and offset operands are obtained. In step 514, the offset is shifted left by 1 bit. In step 516, the offset is sign extended. In step 518, offset is added to the address of the instruction after the branch to create a target address. In an embodiment, this target address is a PC-relative target address. In step 520, 2 is added to the address of the instruction after the branch, and the result is placed in GPR[31]. In step 522, if the contents of GPR(rs) is greater than or equal to zero, then operation proceeds to step 524, where the instruction after the branch instruction is executed. In an embodiment, the instruction is in a delay slot. In step 526, Branch to target address. In step 522, if the contents of GPR(rs) is less than zero then the operation ends at 523.

In an embodiment, the restrictions on the BGEZALS instruction are that the delay-slot instruction must be 16-bits in size. In an embodiment, processor operation is unpredictable if a 32-bit instruction is placed in the delay slot of the BGEZALS instruction. In an embodiment, processor operation is unpredictable if a branch, jump, ERET, DERET, or WAIT instruction is placed in the delay slot of a branch or jump. GPR 31 must not be used for the source register rs, because such an instruction does not have the same effect when reexecuted. The result of executing such an instruction is unpredictable. This restriction permits an exception handler to resume execution by reexecuting the branch when an exception occurs in the branch delay slot.

Pseudocode describing the above operation is provided as follows:

| Operation: | |
|---|---|
| I: | target_offset ← sign_extend(offset \|\| 0¹) |
| | condition ← GPR[rs] ≧ 0^{GPRLN} |
| | GPR[31] ← PC + 6 |
| I+1 | if condition then |
| | PC ← PC + target_offset |
| | endif |

FIG. 5C is a schematic diagram showing the format for Branch on Less Than Zero and Link, Short Delay-Slot (BLTZALS) instruction according to an embodiment of the present invention. For coding, the format of the BLTZALS instruction is “BLTZALS rs, offset” where

In an embodiment, the purpose of the BLTZALS instruction is to test a GPR then do a PC-relative conditional procedure call.

FIG. 5D is a flowchart illustrating operation of a BLTZALS instruction according to an embodiment. In step 528, the values of register (rs) and offset operands are obtained. In step 530, the offset is shifted left by 1 bit. In step 532, the offset is sign extended. In step 534, the offset is added to the address of the instruction after the branch to create target address. In step 536, 2 is added to the address of instruction after the branch, and the result is placed in GPR[31]. In step 538, if the contents of GPR[rs] is less than zero then operation proceeds to step 540, where the instruction after the branch instruction is executed. In step 542, Branch to target address. If the contents of GPR[rs] is greater than or equal to zero then the operation ends at step 539.

In an embodiment, the restrictions on the BLTZALS instruction are that the delay-slot instruction must be 16-bits in size. Processor operation in an embodiment is unpredictable if a 32-bit instruction is placed in the delay slot of BLTZALS, and GPR 31 cannot be used for the source register rs, because such an instruction does not have the same effect when reexecuted. In an embodiment, this restriction permits an exception handler to resume execution by reexecuting the branch when an exception occurs in the branch delay slot. Processor operation in an embodiment, is unpredictable if a branch, jump, ERET, DERET, or WAIT instruction is placed in the delay slot of a branch or jump. In an embodiment, the BLTZALS instruction has no exceptions.

Pseudocode describing the above operation is provided as follows:

| Operation: | |
|---|---|
| I: | target_offset ← sign_extend(offset \|\| 0¹) |
| | condition ← GPR[rs] < 0^{GPRLN} |
| | GPR[31] ← PC + 6 |
| I+1 | if condition then |
| | PC ← PC + target_offset |
| | endif |

FIG. 5E is a schematic diagram showing the format for Jump and Link Register, Short Delay-Slot (16-bit) (JALRS16) instruction according to an embodiment of the present invention. For coding, the format of the JALRS16 instruction is “JALRS 16 rs” where rs is a general purpose register.

In an embodiment, the purpose of the JALRS 16 instruction is to execute a procedure call to an instruction address in a register, e.g., GPR[31]←return_addr, PC←GPR[rs].

FIG. 5F is a flowchart illustrating operation of a JALRS16 instruction according to an embodiment. In step 544, the value of register rs is obtained. In step 546, the effective target ISA mode is set to the value in bit zero of GPR[rs]. In step 548, the effective target address is set to the value in GPR[rs] with bit 0 cleared. In step 550, 2 is added to the address of the instruction after the jump, and this result is placed in GPR[31]. In step 552, the instruction after the jump instruction is executed. In step 554, operation jumps to the effective target address, and the ISA mode is set to the effective target ISA mode. The operation ends at step 556.

In an embodiment, the restrictions on the JALRS 16 instruction are that the delay-slot instruction must be 16-bits in size. In an embodiment, processor operation is unpredictable if a 32-bit instruction is placed in the delay slot of the JALRS16 instruction. In an embodiment, the effective target address in GPR rs must be naturally-aligned.

In an embodiment, if bit 0 is zero and bit 1 is one, an address error exception occurs when the jump target is subsequently fetched as an instruction. In an embodiment, bit 0 of the target address is maintained at zero to prevent address exceptions when bit 0 of the source register is one. In an embodiment, processor operation is unpredictable if a branch, jump, ERET, DERET, or WAIT instruction is placed in the delay slot of a branch or jump.

In an embodiment, the JALRS 16 instruction has no exceptions.

Pseudocode describing the above operation is provided as follows:

| Operation: | |
|---|---|
| I: | temp ← GPR[rs] |
| | GPR[31] ← PC + 4 |
| I+1: | if Config3_{ISA} = 0 then |
| | PC ← temp |
| | else |
| | PC ← temp_{GPRLEN-1..1} \|\| 0 |
| | ISAMode ← temp₀ |
| | endif |

FIG. 5G is a schematic diagram showing the format for Jump and Link Register, Short Delay Slot (JALRS) instruction according to an embodiment of the present invention. For coding, the format of the JALRS instruction is “JALRS rs (rt=31 implied)” and “JALRS rt, rs” where rt and rs are general purpose registers.

In an embodiment, the purpose of the JALRS instruction is to execute a procedure call to an instruction address in a register, e.g., GPR[rt]←return_addr, PC←GPR[rs].

FIG. 5H is a flowchart illustrating operation of a JALRS instruction according to an embodiment. In step 558, the value of registers rs and rt are obtained. In step 560, the effective target ISA mode is set to the value in bit zero of GPR[rs]. In step 562, the effective target address is set to the value in GPR[rs] with bit 0 cleared. In step 564, 2 is added to the address of the instruction after the jump, and this result is placed in GPR[rt]. In step 566, the instruction after the jump instruction is executed. In step 568, operation jumps to the effective target address, and the ISA mode is set to the effective target ISA mode. The operation ends at step 570.

In an embodiment, the restrictions on the JALRS instruction are that the delay-slot instruction must be 16-bits in size. In an embodiment, processor operation is unpredictable if a 32-bit instruction is placed in the delay slot of JALRS. Another restriction in an embodiment is that register specifiers rs and rt cannot be set equal to each other, because such values do not have the same result when reexecuted. In an embodiment, processor operation is unpredictable if a branch, jump, ERET, DERET, or WAIT instruction is placed in the delay slot of a branch or jump.

In an embodiment, the JALRS instruction has no exceptions.

Pseudocode describing the above operation is provided as follows:

| Operation: | |
|---|---|
| I: | temp ← GPR[rs] |
| | GPR[rt] ← PC + 6 |
| I+1: | if Config1_{CA} = 0 then |
| | PC ← temp |
| | else |
| | PC ← temp_{GPRLEN-1..1} \|\| 0 |
| | ISAMode ← temp₀ |
| | endif |

FIG. 5I is a schematic diagram showing the format for Jump and Link Register with Hazard Barrier, Short Delay-Slot (JALRS.HB) instruction according to an embodiment of the present invention. For coding, the format of the JALRS.HB instruction is “JALRS rs (rt=31 implied)” and “JALRS rt, rs” where rt and rs are general purpose registers.

In an embodiment, the purpose of the JALRS.HB instruction is to execute a procedure call to an instruction address in a register, e.g., GPR[rt]←return addr, PC←GPR[rs].

FIG. 5J is a flowchart illustrating operation of a JALRS.HB instruction according to an embodiment. In step 572, the value of registers rs and rd are obtained In step 576, the effective target ISA mode is set to the value in bit zero of GPR[rs]. In step 578, the effective target address is set to the value in GPR[rs] with bit 0 cleared. In step 580, 2 is added to the address of the instruction after the jump, and this result is placed in GPR[rd]. In step 582, the instruction after the jump instruction is executed. In step 584, all instruction execution hazards are cleared. In step 586, operation jumps to the effective target address, and the ISA mode is set to the effective target ISA mode. The operation ends at step 588.

An embodiment of the JALRS.HB instruction implements a software barrier that resolves all execution and instruction hazards created by Coprocessor 0 state changes. The effects of this barrier in embodiments are manifested, for example, in the fetch and decode steps of the instruction referenced by the PC to which an embodiment of the JALRS.HB instruction jumps. An equivalent barrier is also implemented by the ERET instruction, but that instruction is only available if access to Coprocessor 0 is enabled, whereas an embodiment of the JALRS.HB instruction is usable all operating modes. An embodiment the JALRS.HB instruction clears both execution and instruction hazards.

In an embodiment, the restrictions on the JALRS instruction are that the delay-slot instruction must be 16-bits in size. In an embodiment, processor operation is unpredictable if a 32-bit instruction is placed in the delay slot of JALRS.HB, and register specifiers rs and rd must not be equal, because such an instruction does not have the same effect (is unpredictable) when reexecuted. In an embodiment, processor operation is also unpredictable if a branch, jump, ERET, DERET, or WAIT instruction is placed in the delay slot of a branch or jump. In an embodiment, the JALRS.HB instruction has no exceptions.

Pseudocode describing the above operation is provided as follows:

| Operation: | |
|---|---|
| I: | temp ← GPR[rs] |
| | GPR[rt] ← PC + 6 |
| I+1: | if Config1_{CA} = 0 then |
| | PC ← temp |
| | else |
| | PC ← temp_{GPRLEN-1..1} \|\| 0 |
| | ISAMode ← temp₀ |
| | endif |
| | ClearHazards ( ) |

In an embodiment of the ISA described herein, the JALR instruction, the JALR.HB instruction, the JALR16 instruction, the JALRS 16 instruction the JALRS instruction, and the JALRS.HB instruction are the only branch-and-link instructions that can select a register for the return link; all other link instructions use a specific register, e.g., GPR 31. In an embodiment of the JALRS.HB instruction, the default register for GPR rt, if omitted in the assembly language instruction, is GPR 31.

An embodiment of the JALRS.HB instruction clears execution and instruction hazards before execution continues. In an embodiment, a hazard is created when a Coprocessor 0 or TLB write affects execution or the mapping of the instruction stream, or after a write to the instruction stream, and when such a situation exists, software must explicitly indicate to hardware that the hazard should be cleared. In an embodiment, execution hazards alone can be cleared with the EHB instruction, and instruction hazards can only be cleared with a JR.HB, JALRS.HB, or ERET instruction, such instructions causing the hardware to clear the hazard before the instruction at the target of the jump is fetched. It should be noted that, in an embodiment, because the JR.HB, JALRS.HB, and ERET instructions are encoded as jumps, the process of clearing an instruction hazard can often be included as part of a call (JALR) or return (JR) sequence, by simply replacing the original instructions with the JALRS.HB equivalent.

### Example: Clearing Hazards Due to an ASID Change

| /* | | |
|---|---|---|
| * | Code used to modify ASID and call a routine with the new | |
| * | mapping established. | |
| * | a0 = New ASID to establish | |
| * | a1 = Address of the routine to call | |
| */ | | |
| mfc0 | v0, | C0_EntryHi /* Read current ASID */ |

| | | | |
|---|---|---|---|
| li | v1, | ~M_EntryHiASID | /* Get negative mask for field */ |
| and | v0, | v0, v1 | /* Clear out current ASID value */ |
| or | v0, | v0, a0 | /* OR in new ASID value */ |
| mtc0 | v0, | C0_EntryHi | /* Rewrite EntryHi with new ASID */ |
| JALRS.HB | | a1 | /* Call routine, clearing the |
| hazard */ | | | |
| nop | | | |

FIG. 5K is a schematic diagram showing the format for a Jump and Link, Short Delay Slot (JALS) instruction according to an embodiment of the present invention. In an embodiment, the purpose of the JALS instruction is to execute a procedure call within the current 128 MB-aligned region.

FIG. 5L is a flowchart illustrating operation of a JALS instruction according to an embodiment. In step 590, a 26-bit instr index field is obtained from the instruction. In step 591, the 26-bit instr index field is left shifted by 1 bit. In step 592, bits 31 . . . 27 of the address of the instruction after the jump are concatenated to the left shifted 26-bit instr_index field to obtain effective target address. In step 593, 2 is added to the address of the instruction after the jump, and the result is placed in GPR[31]. In step 594, the instruction after the jump instruction is executed. In step 595, a jump to the effective target address is performed. The operation ends at step 596.

In an embodiment, the restrictions on the JALS instruction are that the delay-slot instruction must be 16-bits in size. In an embodiment, processor operation is unpredictable if a 32-bit instruction is placed in the delay slot of JALS. In an embodiment, processor operation is also unpredictable if a branch, jump, ERET, DERET, or WAIT instruction is placed in the delay slot of a branch or jump. In an embodiment, the JALS instruction has no exceptions.

Pseudocode describing the above operation is provided as follows:

Operation:
I: GPR[31] ← PC + 6
I+1: = PC ← PC_{GPRLEN-1..27} || instr_index || 0¹

### VI. Example Processor Core

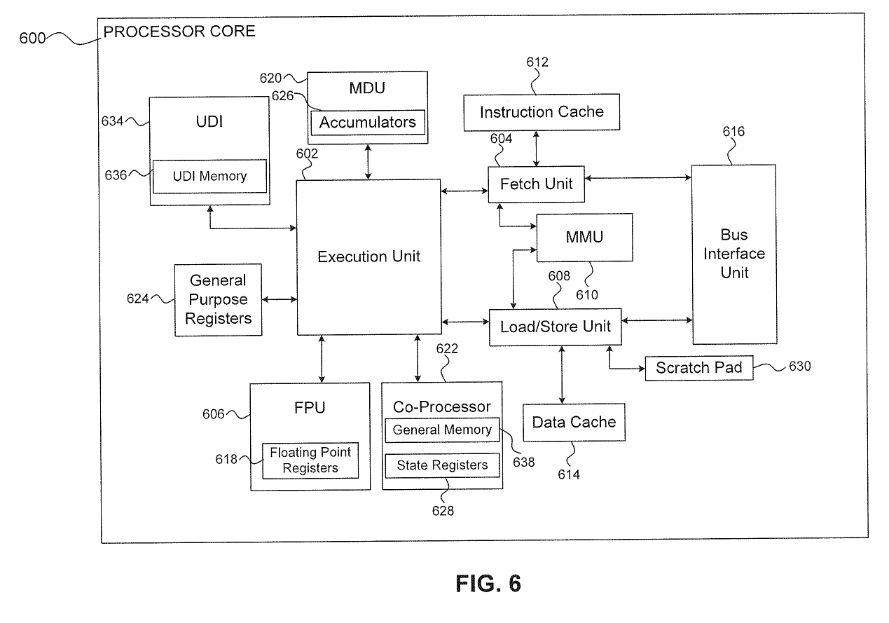

FIG. 6 is a schematic diagram of an exemplary processor core 600 according to an embodiment of the present invention for implementing an ISA according to embodiments of the present invention. Processor core 600 is an exemplary processor intended to be illustrative, and not intended to be limiting. Those skilled in the art would recognize numerous processor implementations for use with an ISA according to embodiments of the present invention.

As shown in FIG. 6, processor core 600 includes an execution unit 602, a fetch unit 604, a floating point unit 606, a load/store unit 608, a memory management unit (MMU) 610, an instruction cache 612, a data cache 614, a bus interface unit 616, a multiply/divide unit (MDU) 620, a co-processor 622, general purpose registers 624, a scratch pad 630, and a core extend unit 634. While processor core 600 is described herein as including several separate components, many of these components are optional components and will not be present in each embodiment of the present invention, or components that may be combined, for example, so that the functionality of two components reside within a single component. Additional components may also be added. Thus, the individual components shown in FIG. 6 are illustrative and not intended to limit the present invention.

Processor core 600, in an embodiment, is a Reduced Instruction Set Computer (RISC) processor, one of the characteristics of this type of processor being, as would be known by one having skill in the art, that it uses instructions that accomplish simple functions and directly accesses register addresses. An RISC processor embodiment can be implemented in a RISC architecture, an example of which is described below.

An embodiment of execution unit 602 implements a load-store (RISC) architecture with single-cycle arithmetic logic unit operations (e.g., logical, shift, add, subtract, etc.). Execution unit 602 interfaces with fetch unit 604, floating point unit 606, load/store unit 608, multiple-divide unit 620, co-processor 622, general purpose registers 624, and core extend unit 634.

Fetch unit 604 is responsible for providing instructions to execution unit 602. In one embodiment, fetch unit 604 includes control logic for instruction cache 612, a recoder for recoding compressed format instructions, dynamic branch prediction and an instruction buffer to decouple operation of fetch unit 604 from execution unit 602. Fetch unit 604 interfaces with execution unit 602, memory management unit 610, instruction cache 612, and bus interface unit 616.

Floating point unit 606 interfaces with execution unit 602 and operates on non-integer data. Floating point unit 606 includes floating point registers 618. In one embodiment, floating point registers 618 may be external to floating point unit 606. Floating point registers 618 may be 32-bit or 64-bit registers used for floating point operations performed by floating point unit 606. Typical floating point operations are arithmetic, such as addition and multiplication, and may also include exponential or trigonometric calculations.

Load/store unit 608 is responsible for data loads and stores, and includes data cache control logic. Load/store unit 608 interfaces with data cache 614 and scratch pad 630 and/or a fill buffer (not shown). Load/store unit 608 also interfaces with memory management unit 610 and bus interface unit 616.

Memory management unit 610 translates virtual addresses to physical addresses for memory access. In one embodiment, memory management unit 610 includes a translation lookaside buffer (TLB) and may include a separate instruction TLB and a separate data TLB. Memory management unit 610 interfaces with fetch unit 604 and load/store unit 608.

Instruction cache 612 is an on-chip memory array organized as a multi-way set associative or direct associative cache such as, for example, a 2-way set associative cache, a 4-way set associative cache, an 8-way set associative cache, et cetera. Instruction cache 612 is preferably virtually indexed and physically tagged, thereby allowing virtual-to-physical address translations to occur in parallel with cache accesses. In one embodiment, the tags include a valid bit and optional parity bits in addition to physical address bits. Instruction cache 612 interfaces with fetch unit 604.

Data cache 614 is also an on-chip memory array. Data cache 614 is preferably virtually indexed and physically tagged. In one embodiment, the tags include a valid bit and optional parity bits in addition to physical address bits. Data cache 614 interfaces with load/store unit 608.

Bus interface unit 616 controls external interface signals for processor core 600. In an embodiment, bus interface unit 616 includes a collapsing write buffer used to merge write-through transactions and gather writes from uncached stores.

Multiply/divide unit 620 performs multiply and divide operations for processor core 600. In one embodiment, multiply/divide unit 620 preferably includes a pipelined multiplier, accumulation registers (accumulators) 626, and multiply and divide state machines, as well as all the control logic required to perform, for example, multiply, multiply-add, and divide functions. As shown in FIG. 6, multiply/divide unit 620 interfaces with execution unit 602. Accumulators 626 are used to store results of arithmetic performed by multiply/divide unit 620.

Co-processor 622 performs various overhead functions for processor core 600. In one embodiment, co-processor 622 is responsible for virtual-to-physical address translations, implementing cache protocols, exception handling, operating mode selection, and enabling/disabling interrupt functions. Co-processor 622 interfaces with execution unit 602. Co-processor 622 includes state registers 628 and general memory 638. State registers 628 are generally used to hold variables used by co-processor 622. State registers 628 may also include registers for holding state information generally for processor core 600. For example, state registers 628 may include a status register. General memory 638 may be used to hold temporary values such as coefficients generated during computations. In one embodiment, general memory 638 is in the form of a register file.

General purpose registers 624 are typically 32-bit or 64-bit registers used for scalar integer operations and address calculations. In one embodiment, general purpose registers 624 are a part of execution unit 624. Optionally, one or more additional register file sets, such as shadow register file sets, can be included to minimize content switching overhead, for example, during interrupt and/or exception processing.

Scratch pad 630 is a memory that stores or supplies data to load/store unit 608. The one or more specific address regions of a scratch pad may be pre-configured or configured programmatically while processor 600 is running. An address region is a continuous range of addresses that may be specified, for example, by a base address and a region size. When base address and region size are used, the base address specifies the start of the address region and the region size, for example, is added to the base address to specify the end of the address region. Typically, once an address region is specified for a scratch pad, all data corresponding to the specified address region are retrieved from the scratch pad.

User Defined Instruction (UDI) unit 634 allows processor core 600 to be tailored for specific applications. UDI 634 allows a user to define and add their own instructions that may operate on data stored, for example, in general purpose registers 624. UDI 634 allows users to add new capabilities while maintaining compatibility with industry standard architectures. UDI 634 includes UDI memory 636 that may be used to store user added instructions and variables generated during computation. In one embodiment, UDI memory 636 is in the form of a register file.

### VII. Software Embodiments

For example, in addition to implementations using hardware (e.g., within or coupled to a Central Processing Unit (“CPU”), microprocessor, microcontroller, digital signal processor, processor, processor core, System on Chip (“SOC”), or any other programmable or electronic device), implementations may also be embodied in software (e.g., computer readable code, program code and/or instructions disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), hardware description languages (HDL) including Verilog HDL, VHDL, SystemC Register Transfer Level (RTL) and so on, or other available programs, databases, and/or circuit (i.e., schematic) capture tools. Such software can be disposed in any known computer usable medium including semiconductor, magnetic disk, optical disk (e.g., CD-ROM, DVD-ROM, etc.) and stored as a computer data signal embodied in a computer usable (e.g., readable) medium (e.g., any other medium including digital, optical, or analog-based medium). As such, the software can be transmitted over communication networks including the Internet and intranets.

It should be understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software.

### VIII. Conclusion

The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

1. A RISC processor to execute instructions belonging to an instruction set architecture having at least two different sizes, comprising:
an instruction fetch unit configured to fetch at least one instruction per cycle;
an instruction decode unit configured to determine a size of each fetched instruction and decode each fetched instruction according to its determined size; and
an execution unit configured to execute the decoded instructions, wherein the instructions in the instruction set architecture are backward compatible for a compiler used with a legacy processor.

2. The RISC processor of claim 1, wherein the instruction size for a particular instruction in the instruction set architecture is determined based on a statistical analysis of instruction usage.

3. The RISC processor of claim 2, wherein a smaller size instruction is provided for instructions that are more often used.

4. The RISC processor of claim 1, wherein the instruction set architecture comprises instructions having only three sizes.

5. The RISC processor of claim 3, wherein the instruction set architecture comprises:
a first group of instructions having 16 bits; and
a second group of instructions having 32 bits.

6. A method of creating a new processor instruction set architecture (ISA) by re-encoding an existing ISA, comprising:
collecting data, using a computer, corresponding to execution values over a period of usage for an existing instruction from the existing ISA;
analyzing the collected data, using a given computer; and
re-encoding a new instruction for the new ISA from the existing instruction and the analyzing.

7. The method of claim 6, wherein the new instruction has a smaller bit-length than the existing instruction.

8. The method of claim 6, wherein the analyzing comprises analyzing using statistical analysis.

9. The method of claim 6, wherein the execution values comprise target registers and the new instruction uses encoding to reference a reduced set of target registers.

10. The method of claim 6, wherein the execution values comprise immediate values and the new instruction uses encoding values to receive a reduced set of possible immediate values.

11. The method of claim 10, wherein at least one encoded value is based on a specific characteristic of a computer on which the new ISA is encoded to be executed.

12. A tangible computer readable storage medium that includes a processor embodied in software, the processor comprising:
an instruction fetch unit configured to fetch a first instruction, such first instruction being associated with a first instruction set architecture (ISA);
an instruction decode unit configured to determine a size of the first instruction and decode the first instruction according to its determined size; and
an execution unit configured to execute the decoded first instruction, wherein the size of an argument of the first instruction is determined by a statistical analysis of a second instruction.

13. The tangible computer readable storage medium of claim 12, wherein the second instruction is associated with a second ISA.

14. The tangible computer readable storage medium of claim 12, wherein the statistical analysis comprises analyzing usage of the second instruction over a period of time and determining a frequency of used argument values.

15. The tangible computer readable storage medium of claim 12, wherein the statistical analysis comprises analyzing usage of the second instruction and other instructions over a period of time and determining the frequency of use of the second instruction compared to the other instructions.

16. The tangible computer readable storage medium of claim 12, wherein the execution unit is configured to execute the decoded first instruction, wherein the first instruction was re-encoded from the second instruction based on the statistical analysis.

17. The tangible computer readable storage medium of claim 12, wherein the first instruction is configured to receive an encoded argument value.

18. The tangible computer readable storage medium of claim 17, wherein the encoded argument value is determined based upon a characteristic of the processor.

19. The tangible computer readable storage medium of claim 17, wherein the encoded argument value is an immediate value.

20. The tangible computer readable storage medium of claim 17, wherein the encoded argument value is a target register value.

21. A processor comprising:
an instruction fetch unit configured to fetch a first instruction, the first instruction being associated with a first instruction set architecture (ISA);
an instruction decode unit configured to determine a size of the first instruction and decode the first instruction according to its determined size; and
an execution unit configured to execute the decoded first instruction, wherein the first instruction is a combination of a second and a third instruction, and wherein the first instruction accepts an encoded argument value, the encoded argument value corresponding to an un-encoded argument from one of, the second instruction and the third instruction.

22. The processor of claim 21 wherein the second and third instruction are associated with a second ISA.

23. The processor of claim 21 wherein the encoded argument value is generated by a process comprising:
analyzing usage of the un-encoded argument over a period of time; and
selecting and encoding a plurality of arguments for use by the first instruction.

24. The processor of claim 23 wherein the plurality of arguments selected correspond to arguments determined by the analyzing to be those arguments that are most frequently used by the second instruction.

25. A method for executing a compact branch on equal to zero instruction on a processor, the method comprising:
receiving at the processor a sequence of bits corresponding to an instruction;
decoding, using a decoder, an opcode portion of the instruction, the opcode indicating that the instruction is a compact branch on equal to zero instruction;
decoding, using the decoder, an rs value and an offset value from the instruction;
shifting the offset value by a pre-determined number of bits;
extending the sign of the offset value;
forming a target address by adding the offset value to a memory address of the instruction;
determining whether the contents of a GPR address are equal to zero, the GPR address corresponding to the rs value; and
if the checked GPR contents are equal to zero then,
branching to the target address.

26. The method of claim 25, wherein:
the instruction bit length is 32 bits;
the opcode portion of the instruction comprises a major opcode and a minor opcode;
the bit length of the major opcode portion of the instruction is 6 bits;
the bit length of the minor opcode portion of the instruction is 5 bits;
the bit length of the offset portion is 16 bits; and
the bit length of the rs portion of the instruction is 5 bits.

27. A method for executing a load word multiple instruction on a processor, the method comprising:
receiving at the processor a sequence of bits corresponding to an instruction;
decoding, using a decoder, an opcode portion of the instruction, the opcode indicating that the instruction is a load word multiple instruction;
decoding, using the decoder, a register list, an offset value and a base operand portion of the instruction;
extending the sign of the offset value;
forming an effective address by the unsigned addition of the contents of a GPR address and the sign-extended offset value, the GPR address corresponding to the base operand value;
performing the following for each register listed in the register list:
retrieving a memory word from memory at the effective address;
extending the sign of the retrieved memory word to the length of a GPR register;
storing the retrieved memory word in a GPR address, the GPR address corresponding to a value stored in the register list; and
incrementing the effective address to the next memory word.

28. The method of claim 27, wherein:
the instruction bit length is 32 bits;
the opcode portion of the instruction comprises a major opcode and a minor opcode;
the bit length of the major opcode portion of the instruction is 6 bits;
the bit length of the minor opcode portion of the instruction is 4 bits;
the bit length of the register list portion of the instruction is 5 bits;
the bit length of the base operand portion is 5 bits; and
the bit length of the offset portion of the instruction is 12 bits.

29. A method for executing a jump register adjust stack pointer instruction on a processor, the method comprising:
receiving at the processor a sequence of bits corresponding to an instruction;
decoding, using a decoder, an opcode portion of the instruction, the opcode indicating that the instruction is a jump register adjust stack pointer instruction;
decoding, using the decoder, an increment value portion of the instruction;
retrieving the values stored in a first general purpose register and a second general purpose register;
shifting the increment value left by a pre-determined number of bits;
adding the left shifted immediate value to the value stored in the second register and placing the results in the first register;
setting the effective target address to the value stored in the first register;
clearing the 0 bit of the effective target address;
setting an instruction set architecture mode bit to the value stored in bit 0 of the second register; and
jumping to the effective target address.

30. The method of claim 29, wherein:
the instruction bit length is 16 bits;
the opcode portion of the instruction comprises a major opcode and a minor opcode;
the bit length of the major opcode portion of the instruction is 6 bits;
the bit length of the minor opcode portion of the instruction is 5 bits; and
the bit-length of the immediate increment portion of the instruction is 5 bits.

31. A method for executing an add immediate unsigned word register select instruction on a processor, the method comprising:
receiving at the processor a sequence of bits corresponding to an instruction;
decoding, using a decoder, an opcode portion of the instruction, the opcode indicating that the instruction is an add immediate unsigned word register select instruction;
decoding, using the decoder, portions of the instruction corresponding to an instruction immediate value and a register index value;
extending the sign of the instruction immediate value;
adding a value stored in a GPR address to the sign-extended instruction immediate value, the GPR address corresponding to the register index value;
placing a result of the adding in the GPR address, wherein,
the instruction bit length is 16 bits;
the opcode portion of the instruction comprises a major opcode and a minor opcode;
the bit length of the major opcode portion of the instruction is 6 bits;
the bit length of the minor opcode portion of the instruction is 1 bits;
the bit length of the register index portion of the instruction is 5 bits; and
the bit length of the instruction immediate portion of the instruction is 4 bits.

32. A method for executing a move a pair of registers instruction on a processor, the method comprising:
receiving at the processor a sequence of bits corresponding to an instruction;
decoding, using a decoder, an opcode portion of the instruction, the opcode indicating that the instruction is a move a pair of registers instruction;
decoding, using the decoder, portions of the instruction corresponding to a first encoded register address value, a second encoded register address value and an encoded destination address value;
converting the first encoded register address value to a first decoded register address value;
converting the second encoded register address value to a second decoded register address value;
determining a third and fourth decoded register address value from the encoded destination address value;
copying the contents of a first register to a third register, the first register address corresponding to the first decoded register address value and the third register address corresponding to the third decoded register address value; and
copying the contents of a second register to a fourth register, the second register address corresponding to the second decoded register address value and the fourth register address corresponding to the fourth decoded register address value.

33. The method of claim 32, wherein:
the instruction bit length is 16 bits;
the opcode portion of the instruction comprises a major opcode and a minor opcode;
the bit length of the major opcode portion of the instruction is 6 bits;
the bit length of the minor opcode portion of the instruction is 1 bits;
the bit length of the following portions of the instruction is 3-bits:
the first encoded register value,
the second encoded register value, and
the encoded destination value; and
the bit length of the following is 5-bits:
the first decoded register value,
the second decoded register value,
the third decoded register value, and
the fourth decoded register value.

34. A method for executing a jump and link instruction with a delay slot on a processor, the method comprising:
receiving at the processor a sequence of bits corresponding to an instruction;
decoding, using a decoder, an opcode portion of the instruction, the opcode indicating that the instruction is a jump and link with a delay slot instruction; decoding, using the decoder, a portion of the instruction corresponding to an instruction index;
shifting the instruction index to the left by a pre-determined shift amount;
forming an effective target address by concatenating a specific number of bits from the delay slot address to the left-shifted instruction index;
forming a return address by adding a value to the address of the instruction, wherein the ISA within which the instruction is executed has a variable bit-length and the value added is dependant upon the size of the delay slot instruction;
placing the return address in a GPR;
receiving at the processor a sequence of bits corresponding to a delay-slot address;
decoding, using a decoder, the instruction located at the delay-slot address;
executing the delay slot instruction; and
jumping to the formed effective target address.

35. The method of claim 34, wherein:
the instruction bit length is 32 bits;
the bit length of the opcode portion of the instruction is 6 bits;
the bit length of the instruction index is 26 bits; and
the value added is either 2 or 4.
